(19) United States
(12) Patent Application Publication
(10) Pub. No.: US 2026/0322899 A1
(43) Pub. Date: Oct. 15, 2026

(54) ACCESSORY DEVICE FOR USE WITH ELECTRONIC DEVICE

(71) Applicant: SAMSUNG ELECTRONICS CO., LTD., Suwon-si (KR)

(72) Inventors: Janghyun NAM, Suwon-si (KR); Hyoseok NA, Suwon-si (KR); Wonho LEE, Suwon-si (KR)

(21) Appl. No.: 19/684,188

(22) Filed: May 21, 2026

Related U.S. Application Data
(63) Continuation of application No. PCT/KR2024/015812, filed on Oct. 17, 2024.

(30) Foreign Application Priority Data
Nov. 22, 2023 (KR) 10-2023-0163720
Dec. 22, 2023 (KR) 10-2023-0190472

(51) Int. Cl. H04M 1/02; H04M 1/72409

(52) U.S. Cl. CPC H04M 1/0203; H04M 1/72409

(57) ABSTRACT

An accessory device may be used together with an electronic device. The accessory device may include a receptacle including a bottom wall and side walls extending from the bottom wall. The bottom wall and the side walls may define an internal volume having a size and shape to receive the electronic device. The accessory device may include an antenna for near field communication (NFC), embedded in the bottom wall.

### CROSS-REFERENCE TO RELATED APPLICATIONS

This application is a continuation of International Application No. PCT/KR2024/015812 designating the United States, filed on October 17, 2024, in the Korean Ministry of Intellectual Property Receiving Office and claiming priority to Korean Patent Application Nos. 10-2023-0163720, filed on November 22, 2023, and 10-2023-0190472, filed on December 22, 2023, in the Korean Ministry of Intellectual Property, the disclosures of each of which are incorporated by reference herein in their entireties.

### BACKGROUND

### Field

The disclosure relates to an accessory device used together with an electronic device (or a portable electronic device).

### Description of Related Art

An accessory device may be used to carry or protect an electronic device (or a portable electronic device). For example, the accessory device may include a compartment or a receptacle to store the electronic device.

The above-described information may be provided as a related art for the purpose of helping to understand the present disclosure. No assertion or determination is made as to whether any of the above-described information may be applied as a prior art related to the present disclosure.

### SUMMARY

According to an example embodiment, an accessory device is described. The accessory device may be for use with an electronic device. The accessory device may include: a receptacle including a bottom wall and side walls extending from the bottom wall, wherein the bottom wall and the side walls may define an internal volume having a size and a shape configured to receive the electronic device; an antenna configured for near field communication (NFC), embedded in the bottom wall; power supply circuitry, embedded in the bottom wall, connected to the antenna, and configured to be usable for obtaining power for components of the accessory device from the electronic device positioned within the receptacle through the antenna; a first linear regulator comprising circuitry embedded in the bottom wall and connected to the power supply circuit; a second linear regulator comprising circuitry embedded in the bottom wall and connected to the power supply circuit; an integrated circuit, embedded in the bottom wall, connected to the antenna, connected to the power supply circuitry through the first linear regulator, and including wireless communication circuitry configured for NFC, wherein one or more nodes connecting the power supply circuitry and the antenna may also be connected to the integrated circuit; and a circuit, connected to the power supply circuitry through the second linear regulator, configured to be usable for providing information.

According to an example embodiment, an accessory device is described. The accessory device may be for use with an electronic device. The accessory device may include: a receptacle including a bottom wall and side walls extending from the bottom wall, wherein the bottom wall and the side walls may define an internal volume having a size and a shape configured to receive the electronic device; an antenna configured for near field communication (NFC), embedded in the bottom wall; power supply circuitry, embedded in the bottom wall, connected to the antenna, and configured to be usable for obtaining power for components of the accessory device from the electronic device positioned in the receptacle through the antenna; a switch embedded in the bottom wall; one or more nodes connecting the power supply circuitry and the antenna may also be connected to the switch; an integrated circuit, embedded in the bottom wall, connectable to the antenna through the switch, and including wireless communication circuitry configured for NFC; and memory, wherein the memory may store instructions that, when executed by at least one processor, comprising processing circuitry, cause the integrated circuit to control the switch to set a state of the switch to a first state disconnecting the integrated circuitry from the antenna, and control the switch to set the state of the switch to a second state connecting the integrated circuitry to the antenna.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of an accessory device including multiple antennas for near field communication (NFC) according to various example embodiments.

FIG. 2 is a perspective view illustrating an example of an accessory device including a single antenna for NFC according to various example embodiments.

FIGS. 3, 4, 5 and 6 are block diagrams illustrating example configurations of an accessory device including a single antenna usable to assist communication between an electronic device and an external electronic device according to various example embodiments.

FIG. 7 is a block diagram of an example electronic device in a network environment according to various example embodiments.

### DETAILED DESCRIPTION

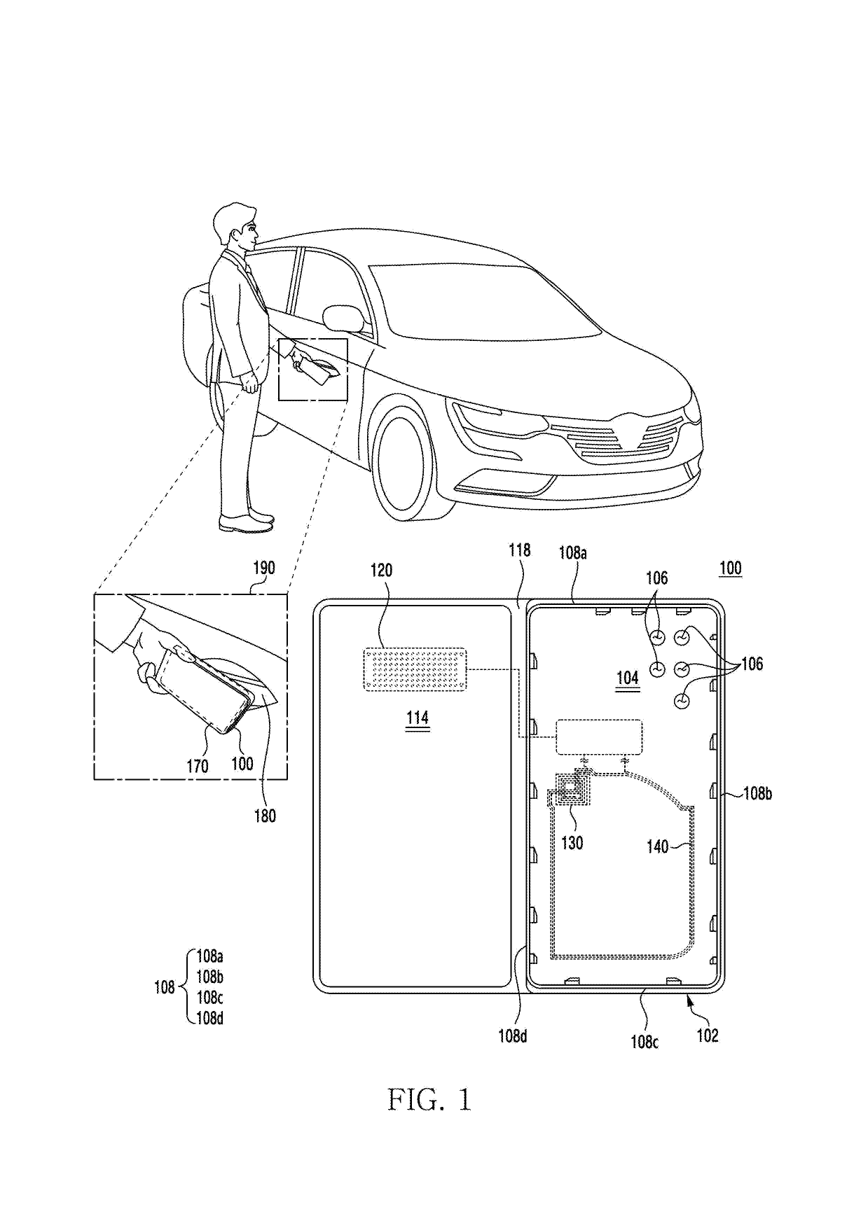

FIG. 1 is a diagram illustrating an example of an accessory device including multiple antennas for near field communication (NFC) according to various example embodiments.

Referring to FIG. 1, an accessory device 100 may be designed for use with an electronic device 170 (or a portable electronic device 170) (e.g., a smartphone or a tablet computing device).

The accessory device 100 may include a receptacle 102 (or a compartment 102). The receptacle 102 may include a wall 104 (or a bottom wall 104). For example, the receptacle 102 may include one or more openings 106 positioned within a location corresponding to one or more cameras of the electronic device 170. The receptacle 102 may include one or more side walls 108 (e.g., a side wall 108a, a side wall 108b, a side wall 108c, and/or a side wall 108d) extending from the wall 104. For example, the wall 104 and the one or more side walls 108 may define an internal volume having a size and a shape to receive the electronic device 170. For example, the receptacle 102 may form an internal volume having a size and a shape corresponding to a size and a shape of the electronic device 170. For example, the accessory device 100 may hold or carry the electronic device 170 within the receptacle 102.

According to an embodiment, the accessory device 100 may include a cover 114. For example, the cover 114 may be connected to the receptacle 102 by a hinge 118. The hinge 118 may allow a relative movement between the cover 114 and the receptacle 102. For example, while the accessory device 100 is in an opened state as in FIG. 1, the cover 114 may be rotated with respect to the receptacle 102 to conceal or protect the electronic device 170 positioned within the receptacle 102. For example, the accessory device 100 may be in the opened state or a closed state that conceals or protects the electronic device 170 positioned within the receptacle 102. It should be noted that the receptacle 102 may be referred to as a receiving portion 102 or a first portion 102 and the cover 114 may be referred to as a front cover 114, a flap 114, a front flap 114, or a second portion 114.

The accessory device 100 may include components for wireless communication. For example, the accessory device 100 may include a wireless communication circuitry (or wireless communication circuitry) for NFC (not shown in FIG. 1). For example, the accessory device 100 may include multiple antennas embedded in the receptacle 102 (or embedded in the wall 104). At least one of the multiple antennas may be for NFC. The multiple antennas may be included in the accessory device 100 for communication between the electronic device 170 and the accessory device 100. For example, the multiple antennas may include a first antenna 130 and a second antenna 140. For example, each of the first antenna 130 and the second antenna 140 may be a coil formed of a conductive pattern.

For example, the first antenna 130 may be used for authentication purposes. For example, the first antenna 130 may be used to receive an authentication request from the electronic device 170. For example, the authentication request may be transmitted from the electronic device 170 to determine, within the electronic device 170, whether the accessory device 100 is made by a manufacturer of the electronic device 170 and/or an approved third-party accessory device manufacturer. For example, the authentication request may be transmitted through an antenna included in the electronic device 170 for NFC. For example, the wireless communication circuitry may obtain the authentication request received through the first antenna 130. For example, the wireless communication circuitry may transmit, through the first antenna 130, authentication information (or an authentication response) in response to the authentication request. For example, the first antenna 130 may be used for transmission of the authentication information. For example, the electronic device 170 may receive the authentication information transmitted through the first antenna 130, and determine, based on the received authentication information, whether the accessory device 100 is made by a manufacturer of the electronic device 170 and/or an approved third-party accessory device manufacturer.

For example, the second antenna 140 may be used to obtain power for components of the accessory device 100 from the electronic device 170,. For example, the second antenna 140 may be used to receive a signal (or a radio frequency (RF) signal) transmitted from the electronic device 170. For example, the signal may be transmitted from the electronic device 170 through an antenna included in the electronic device 170 for NFC. As a non-limiting example, the antenna of the electronic device 170 used to transmit the signal may be the same as an antenna of the electronic device 170 used to transmit the authentication request. For example, the accessory device 100 may include a power supply circuitry (not shown in FIG. 1) connected to the second antenna 140. For example, the power supply circuitry may obtain the power from the signal received from the electronic device 170 through the second antenna 140. For example, at least a portion of the power may be provided to the wireless communication circuitry to obtain the authentication request and transmit the authentication information. For example, the wireless communication circuitry may, using at least a portion of the power, obtain the authentication request and transmit the authentication information through the first antenna 130. For example, the accessory device 100 may (further) include a display 120 embedded in the cover 114. For example, the display 120 may display information obtained from memory (not shown in FIG. 1) in the accessory device 100 (in the closed state). For example, at least a portion of the power may be provided to the display 120 for the display of the information. For example, the display 120 may display the information using at least a portion of the power.

For example, the electronic device 170 may communicate with an external electronic device 180 related to a vehicle through NFC. For example, the communication between the electronic device 170 and the external electronic device 180 may be performed (or executed) for a digital car key stored in the electronic device 170 (or installed in the electronic device 170). For example, the digital car key may be used for locking a door of the vehicle, unlocking the lock of the door, starting the vehicle, and/or turning off the vehicle. For example, a user may tag the electronic device 170 positioned within the receptacle 102 to the external electronic device 180 to unlock the lock of the door of the vehicle, as in a state 190. For example, a quality of the communication between the electronic device 170 and the external electronic device 180 performed (or executed) for the unlock of the lock of the door while the electronic device 170 within the receptacle 102 is tagged to the external electronic device 180 may be reduced due to the first antenna 130 (and/or the second antenna 140) positioned between an antenna of the electronic device 170 and an antenna of the external electronic device 180. As a non-limiting example, since a transmission frequency of a signal transmitted from the electronic device 170 positioned within the receptacle 102 for the unlock of the lock of the door is shifted by the first antenna 130, the quality of the communication between the electronic device 170 within the receptacle 102 and the external electronic device 180 may be reduced. As a non-limiting example, since a reception frequency of a signal received by the electronic device 170 positioned within the receptacle 102 from the external electronic device 180 for the unlock of the lock of the door is shifted by the first antenna 130, the quality of the communication between the electronic device 170 within the receptacle 102 and the external electronic device 180 may be reduced. Since the reduction of the quality of the communication between the electronic device 170 within the receptacle 102 and the external electronic device 180 may cause that the lock of the door is not unlocked while the electronic device 170 within the receptacle 102 is tagged to the external electronic device 180, the reduction of the quality of the communication between the electronic device 170 within the receptacle 102 and the external electronic device 180 may cause inconvenience of the user.

An accessory device illustrated and described in greater detail below through the following descriptions may include a single antenna for NFC, for the quality of the communication between the electronic device 170 within the receptacle 102 and the external electronic device 180. For example, the single antenna may be used to assist communication between the electronic device 170 and the external electronic device 180, performed through NFC. For example, the single antenna may be used to boost a signal transmitted from the electronic device 170 through NFC according to coupling between the single antenna and an antenna (an antenna for NFC) of the electronic device 170. For example, the single antenna may be used to perform authentication with the electronic device 170 through NFC. For example, the single antenna may be used to obtain power for components within the accessory device.

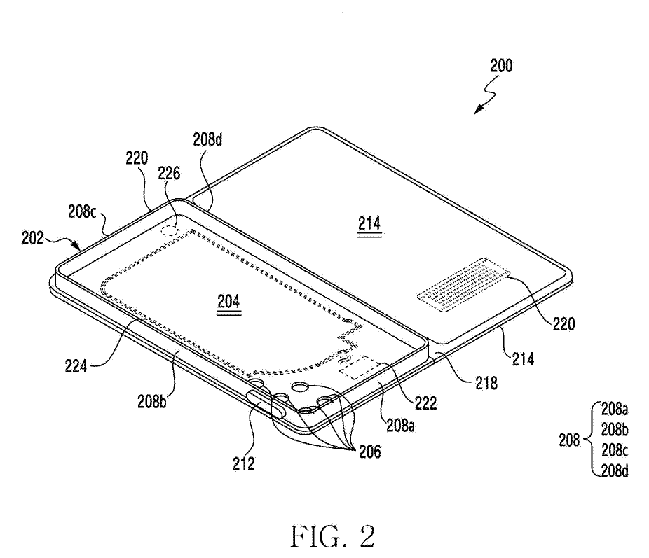

FIG. 2 is a perspective view illustrating an example of an accessory device including a single antenna for near field communication (NFC) according to various example embodiments.

Referring to FIG. 2, an accessory device 200 may be designed for use with an electronic device 170 (or a portable electronic device 170) (e.g., a smartphone or a tablet computing device). As a non-limiting example, the accessory device 200 may include a material (or materials), such as leather, plastic, synthetic leather, and/or silicon.

The accessory device 200 may include a receptacle 202 (or a compartment 202). The receptacle 202 may include a wall 204 (or a bottom wall 204). For example, the receptacle 202 may include one or more openings 206 positioned within a location corresponding to one or more cameras of the electronic device 170. The receptacle 202 may include one or more side walls 208 (e.g., a side wall 208a, a side wall 208b, a side wall 208c, and/or a side wall 208d) extending from the wall 204. For example, the wall 204 and the one or more side walls 208 may define an internal volume having a size and a shape to receive the electronic device 170. For example, the receptacle 202 may form an internal volume having a size and a shape corresponding to a size and a shape of the electronic device 170. For example, the accessory device 200 may surround at least a portion of the electronic device 170 within the receptacle 202. As a non-limiting example, the accessory device 200 may include a button 212 positioned on the side wall 208b. The button 212 may be positioned on the side wall 208b within a location corresponding to a button on the electronic device 170 when the electronic device 170 is positioned within the receptacle 202. For example, the button 212 may be positioned such that a user presses the button 212 to press the button on the electronic device 170.

As a non-limiting example, the accessory device 200 may further include a cover 214. The cover 214 may be connected to the receptacle 202 by a hinge 218. The hinge 218 may allow a relative movement between the cover 214 and the receptacle 202. For example, while the accessory device 200 is in an opened state as in FIG. 2, the cover 214 may be rotated with respect to the receptacle 202 through the hinge 218 to conceal or protect the electronic device 170 positioned within the receptacle 202. For example, the accessory device 200 may be in the opened state or a closed state that conceals or protects the electronic device 170 positioned within the receptacle 202. It should be noted that the receptacle 202 may be referred to as a receiving portion 202 or a first portion 202 and the cover 214 may be referred to as a front cover 214, a flap 214, a front flap 214, or a second portion 214.

The accessory device 200 may include components for wireless communication. For example, the components may be used for communication with the electronic device 170 coupled with the accessory device 200, within the receptacle 202. For example, the components may be used for communication between the electronic device 170 and an external electronic device (e.g., the external electronic device 180 of FIG. 1).

For example, the accessory device 200 may include an integrated circuit 222 including a wireless communication circuitry (or wireless communication circuitry) for NFC. For example, the integrated circuit 222 may be embedded in the wall 204. For example, the wireless communication circuitry may include a wireless communication circuitry for NFC. However, the disclosure is not limited thereto. For example, the wireless communication circuitry may include a wireless communication circuitry for Bluetooth, Bluetooth low energy (BLE), and/or wireless fidelity (Wi-Fi).

For example, the accessory device 200 may include an antenna 224, which is a single antenna embedded in the receptacle 202 (or embedded in the wall 204). For example, the antenna 224 may be for NFC. However, the disclosure is not limited thereto. For example, the antenna 224 may be for Bluetooth, BLE, and/or Wi-Fi. As a non-limiting example, the antenna 224 may be a coil formed of a conductive wire.

For example, the antenna 224 may be used for authentication purposes. For example, the antenna 224 may be used to receive an authentication request from the electronic device 170. For example, the authentication request may be transmitted from the electronic device 170 to determine, within the electronic device 170, whether the accessory device 200 is made by a manufacturer of the electronic device 170 and/or an approved third-party accessory device manufacturer. For example, the authentication request may be transmitted through an antenna included in the electronic device 170. For example, the integrated circuitry 222 may obtain the authentication request received through the antenna 224, using the wireless communication circuit. For example, the integrated circuitry 222 may transmit authentication information (or an authentication response), in response to the authentication request, through the antenna 224 using the wireless communication circuit. For example, the antenna 224 may be used for transmission of the authentication information. For example, the electronic device 170 may receive the authentication information transmitted through the antenna 224, and determine, based on the received authentication information, whether the accessory device 200 is made by a manufacturer of the electronic device 170 and/or an approved third-party accessory device manufacturer. For example, the accessory device 200 may include memory storing instructions for reception of the authentication request and the transmission of the authentication information. As a non-limiting example, the memory may be embedded in the wall 204. As a non-limiting example, the memory may be included in the integrated circuitry 222 embedded in the wall 204. As a non-limiting example, the memory may also be embedded in the cover 214.

For example, the antenna 224 may be used to assist communication between the electronic device 170 within the receptacle 202 and an external electronic device (e.g., the external electronic device 180). For example, the antenna 224 may be used to boost a signal radiated from an antenna of the electronic device 170 to the external electronic device (or toward the external electronic device). As a non-limiting example, the antenna 224 may be coupled with the antenna of the electronic device 170 within the receptacle 202 to assist communication between the electronic device 170 and the external electronic device contacting on another surface of the wall 204 opposite to a surface of the wall 204 at least partially contacting with the electronic device 170 within the receptacle 202. As a non-limiting example, a frequency of a signal radiated from the antenna of the electronic device 170 within the receptacle 202 through the antenna 224 (toward the external electronic device) may be about 13.56 mega-hertz (MHz). As a non-limiting example, a resonance frequency of the antenna 224 may be slightly (or marginally) higher than 13.56 (MHz). For example, the resonance frequency may be about 14 (MHz). As a non-limiting example, at least a portion of the antenna 224 may overlap with the antenna of the electronic device 170 within the receptacle 202 for coupling between the antenna 224 and the antenna of the electronic device 170. As a non-limiting example, the antenna 224 may be the coil (e.g., a coil formed of a conductive wire) having a boost pattern for coupling between the antenna 224 and the antenna of the electronic device 170. As a non-limiting example, a length of the coil, which is the antenna 224, may be longer than a length of another coil, which is the antenna of the electronic device 170. As a non-limiting example, the number of loops of the coil, which is the antenna 224, may be greater than the number of loops of the another coil, which is the antenna of the electronic device 170.

For example, the antenna 224 may be used to obtain power for components of the accessory device 200 from the electronic device 170. For example, the antenna 224 may be used to receive a signal (or a radio frequency (RF) signal) transmitted from the electronic device 170 within the receptacle 202. For example, the signal may be transmitted from the electronic device 170 within the receptacle 202 through an antenna included in the electronic device 170 for NFC. For example, the antenna of the electronic device 170 used to transmit the signal may be the same as an antenna of the electronic device 170 used to transmit the authentication request, or may be different from the antenna of the electronic device 170 used to transmit the authentication request. For example, the accessory device 200 may include a power supply circuitry (shown later) connected to the antenna 224. As a non-limiting example, the power supply circuitry may be embedded in the wall 204. For example, the power supply circuitry may obtain the power from the signal received through the antenna 224 from the electronic device 170 within the receptacle 202. For example, at least a portion of the power may be provided to the integrated circuitry 222 to obtain the authentication request and transmit the authentication information. For example, the integrated circuitry 222 may obtain the authentication request using at least a portion of the power, and may transmit the authentication information through the antenna 224 using at least a portion of the power. For example, the accessory device 200 may (further) include a circuitry usable to provide information. As a non-limiting example, the accessory device 200 may (further) include, as the circuit, a display 220 embedded in the cover 214. For example, the circuitry may provide information obtained from memory within the accessory device 200 (and/or received from the electronic device 170 through the antenna 224). For example, the display 220 may display information obtained from the memory within the accessory device 200 (and/or received from the electronic device 170 through the antenna 224) (in the closed state). As a non-limiting example, the memory may be embedded in the wall 204. As a non-limiting example, the memory may be included in the integrated circuitry 222 embedded in the wall 204. As a non-limiting example, the memory included in the integrated circuitry 222 may include one or more storage mediums (or one or more storage devices) including a register and/or a cache memory. As a non-limiting example, the memory may be embedded in the cover 214. For example, the memory may further (at least temporarily) store instructions executable by the integrated circuitry 222. For example, the memory may (at least temporarily) store instructions causing the integrated circuitry 222 to perform (or execute) operations to be described below. For example, at least a portion of the power may be provided to the circuitry to provide the information. For example, at least a portion of the power may be provided to the display 220 for the display of the information. For example, the display 220 may display the information, using at least a portion of the power. As a non-limiting example, providing the information may be executed according to determining (or checking) that the accessory device 200 is made by a manufacturer of the electronic device 170 and/or an approved third-party accessory device manufacturer based on the authentication information.

The accessory device 200 may further include a target 226 embedded in the wall 204. For example, the target 226 may be detected by the electronic device 170 positioned within the receptacle 202. As a non-limiting example, the target 226 may be a magnet emitting an external magnetic field detectable by a magnetic field sensor (e.g., a Hall sensor) of the electronic device 170. For example, the target 226 may trigger at least a portion of operations of the electronic device 170 and/or the accessory device 200. As a non-limiting example, when the electronic device 170 is positioned within the receptacle 202 and detects the target 226, communication may be initiated (triggered) between the electronic device 170 and the accessory device 200. As a non-limiting example, the communication may include exchange of the authentication request and the authentication information. As a non-limiting example, a state of the wireless communication circuitry within the integrated circuitry 222 may be switched from an inactive state (or a normally off state) to an active state (or a wake up state), in response to a request initiated (or transmitted) from the electronic device 170 when the electronic device 170 is positioned within the receptacle 202 and detects the target 226.

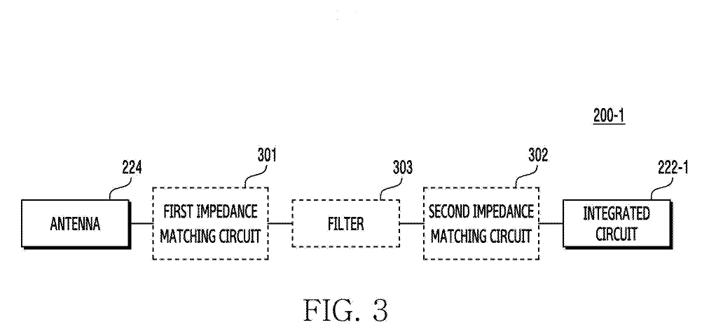

As described above, the antenna 224 may be used for communication between the electronic device 170 within the receptacle 202 and the accessory device 200, and communication between the electronic device 170 within the receptacle 202 and the external electronic device. For example, the antenna 224 may be further used to obtain power for components within the accessory device 200 from the electronic device 170 within the receptacle 202. The accessory device 200 may include components for supporting functions of the antenna 224 described above. The components may be implemented variously. The components implemented variously are described in greater detail below with reference to FIGS. 3, 4, 5 and 6.

FIGS. 3, 4, 5 and 6 are block diagrams illustrating example configurations of an accessory device including a single antenna usable to assist communication between an electronic device and an external electronic device according to various example embodiments.

Referring to FIG. 3, the accessory device 200 may be implemented as an accessory device 200-1. The accessory device 200-1 may include an integrated circuit (e.g., including integrated circuitry) 222-1 and an antenna 224.

The antenna 224 may be used for communication between the electronic device 170 within the receptacle 202 and the accessory device 200-1. The antenna 224 may be used to assist communication between the electronic device 170 within the receptacle 202 and the external electronic device.

For example, the communication between the electronic device 170 within the receptacle 202 and the accessory device 200-1, performed (or executed) through the antenna 224 may include exchange of the authentication request and the authentication information described above with reference to FIG. 2.

For example, the electronic device 170 positioned within the receptacle 202 may detect a target 226. As a non-limiting example, based on receiving (or sensing) (or identifying) an external magnetic field from the target 226, which is a magnet, using a magnetic field sensor of the electronic device 170, the electronic device 170 may detect the target 226. For example, the electronic device 170 may recognize (or identify) (or check) that the electronic device 170 is positioned within the receptacle 202, based on the detection.

For example, the electronic device 170 within the receptacle 202 may transmit the authentication request through an antenna of the electronic device 170 (e.g., an antenna of the electronic device 170 for NFC) based on the detection. As a non-limiting example, the electronic device 170 within the receptacle 202 may transmit a signal (or an RF signal) indicating the authentication request through the antenna of the electronic device 170, according to a reader/writer mode (e.g., a mode operating as an NFC reader) among modes for NFC. As a non-limiting example, the reader/writer mode may be activated (or initiated) (or triggered) based on the detection.

For example, the integrated circuitry of the integrated circuit 222-1 may receive the authentication request from the electronic device 170 through the antenna 224. For example, the integrated circuitry 222-1 may transmit the authentication information through the antenna 224, in response to (or based on) the authentication request received through the antenna 224. As a non-limiting example, the authentication information may indicate a serial number of the accessory device 200-1, a color of the accessory device 200-1, and/or a material of the accessory device 200-1, or the authentication information may include data associated with a serial number of the accessory device 200-1, a color of the accessory device 200-1, and/or a material of the accessory device 200-1. As a non-limiting example, the authentication information may be stored (at least temporarily), in memory of the accessory device 200-1. As a non-limiting example, the memory may include a register and/or a cache memory, included in one or more processing circuits included in the integrated circuitry 222-1. For example, the integrated circuitry 222-1 may, in response to (or based on) receiving the authentication request through the antenna 224, obtain (or read) the authentication information from the memory within the accessory device 200-1, and may transmit a signal including the obtained authentication information through the antenna 224. As a non-limiting example, the integrated circuitry 222-1 may transmit the authentication information through the antenna 224 using at least a portion of power obtained from the signal including the authentication request. As a non-limiting example, the memory of the accessory device 200-1 may store instructions causing the integrated circuitry 222-1 to receive not only the authentication request but also the authentication information and to transmit the authentication information. As a non-limiting example, the instructions may be executed by the integrated circuitry of the integrated circuit 222-1 (or processing circuitry (or a control circuit) within the integrated circuitry 222-1). As a non-limiting example, the memory of the accessory device 200-1 may be embedded in the receptacle 202. As a non-limiting example, the memory of the accessory device 200-1 may be included in the integrated circuitry 222-1 embedded in the receptacle 202.

For example, the electronic device 170 within the receptacle 202 may receive the authentication information through the antenna of the electronic device 170. As a non-limiting example, the electronic device 170 within the receptacle 202 may receive the authentication information through the antenna of the electronic device 170, according to the reader/writer mode. For example, the electronic device 170 may determine, according to the authentication information, whether the accessory device 200-1 is made by a manufacturer of the electronic device 170 and/or an approved third-party accessory device manufacturer. As a non-limiting example, the electronic device 170 may recognize that the accessory device 200-1 is made by a manufacturer of the electronic device 170 and/or an approved third-party accessory device manufacturer, according to the authentication information.

For example, the antenna 224 used for the communication between the electronic device 170 within the receptacle 202 and the accessory device 200-1 may be further used to assist communication between the electronic device 170 within the receptacle 202 and an external electronic device. For example, the electronic device 170 within the receptacle 202 may transmit a signal to the external electronic device that is at least partially adjacent to or contacted with another surface of the wall 204 opposite to a surface of the wall 204 at least partially contacted to the electronic device 170 within the receptacle 202. As a non-limiting example, the signal may be transmitted from the electronic device 170, according to a card emulation mode among the modes for NFC. For example, the signal may be transmitted to the external electronic device, through the antenna of the electronic device 170 and the antenna 224 coupled with the antenna of the electronic device 170. For example, the signal radiated from the antenna of the electronic device 170 may be boosted by the antenna 224 coupled with the antenna of the electronic device 170. For example, the antenna 224 may be coupled with the antenna of the electronic device 170 within the receptacle 202 such that the signal transmitted from the electronic device 170 within the receptacle 202 has enhanced reception quality within the external electronic device.

As a non-limiting example, a transmission frequency of the signal transmitted to the external electronic device through the antenna of the electronic device 170 and the antenna 224 while the electronic device 170 is positioned within the receptacle 202 may be shifted from a transmission frequency of the signal transmitted to the external electronic device through only the antenna of the electronic device 170 while the electronic device 170 is positioned outside the receptacle 202.

As a non-limiting example, the transmission frequency of the signal transmitted to the external electronic device through the antenna of the electronic device 170 and the antenna 224 while the electronic device 170 is positioned within the receptacle 202 may be about 14 (MHz) shifted from about 13.56 (MHz), which is a transmission frequency of the signal transmitted through the antenna of the electronic device 170 while the electronic device 170 is positioned outside the receptacle 202. As a non-limiting example, a resonance frequency of the antenna 224 may be slightly (or marginally) higher than 13.56 (MHz). For example, the resonance frequency may be about 14 (MHz).

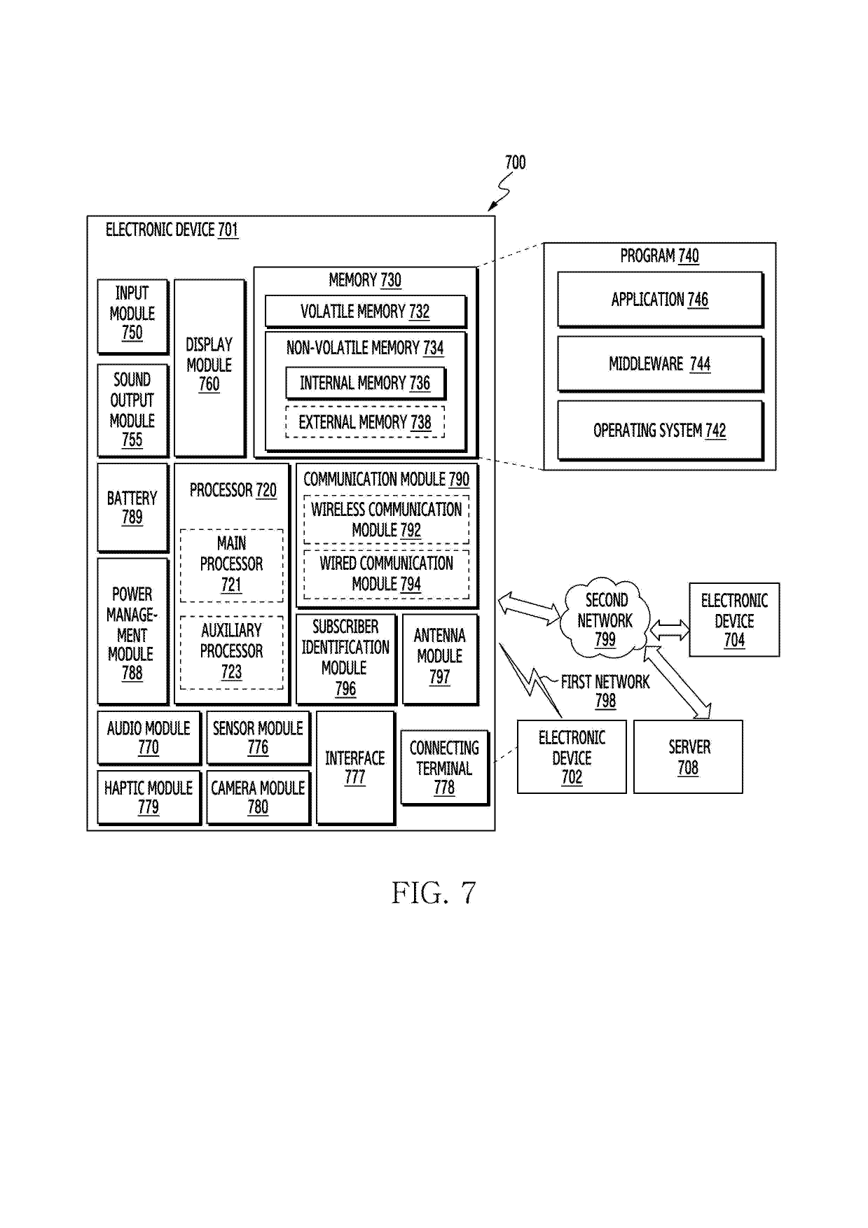

As a non-limiting example, the transmission frequency of the signal transmitted to the external electronic device through the antenna of the electronic device 170 and the antenna 224 while the electronic device 170 is positioned within the receptacle 202 may be about 13.56 (MHz), which is a transmission frequency of the signal transmitted through the antenna of the electronic device 170 while the electronic device 170 is positioned outside the receptacle 202. As a non-limiting example, the electronic device 170 within the receptacle 202 may, based on detection of the target 226, obtain the signal on another transmission frequency (e.g., about 14 (MHz)) shifted from a transmission frequency (e.g., about 13.56 (MHz)) of the signal transmitted to the external electronic device from the electronic device 170 positioned outside the receptacle 202, and transmit the signal on the another transmission frequency through the antenna of the electronic device 170. As a non-limiting example, the signal on the another transmission frequency may be obtained based on the detection and the authentication information. For example, the another transmission frequency (e.g., about 14 (MHz)) of the signal transmitted to the external electronic device may be shifted to the transmission frequency (e.g., about 13.56 (MHz)) by the antenna 224. For example, the transmission frequency of the signal transmitted through the antenna of the electronic device 170 within the receptacle 202 and the antenna 224 may be substantially the same as a transmission frequency of the signal transmitted through the antenna of the electronic device 170 positioned outside the receptacle 202. For example, the electronic device 170 may (at least temporarily) store, in memory of the electronic device 170, instructions for operations for the shifting described above. The instructions may be executed by a processing circuitry (e.g., a processor 720 of FIG. 7) of the electronic device 170.

As a non-limiting example, the signal transmitted to the external electronic device through the antenna of the electronic device 170 and the antenna 224 while the electronic device 170 is positioned within the receptacle 202 may be transmitted, in response to another signal transmitted from the external electronic device to the electronic device 170 within the receptacle 202. For example, the another signal may be received from the external electronic device through the antenna 224 and the antenna of the electronic device 170 within the receptacle 202. As a non-limiting example, the another signal may be boosted by the antenna 224 coupled with the antenna of the electronic device 170 within the receptacle 202. For example, the antenna 224 may be coupled with the antenna of the electronic device 170 within the receptacle 202 such that the signal transmitted from the external electronic device to the electronic device 170 within the receptacle 202 has enhanced reception quality within the electronic device 170 within the receptacle 202.

As a non-limiting example, the accessory device 200-1 may (further) include one or more impedance matching circuits connected to the antenna 224 to set a resonance frequency of the antenna 224 (or a transmission frequency of a signal transmitted through the antenna 224). For example, the accessory device 200-1 may include, as the one or more impedance matching circuits, a first impedance matching circuitry 301 connected to the antenna 224 and a second impedance matching circuitry 302 connected to the antenna 224 through the first impedance matching circuitry 301. As a non-limiting example, the one or more impedance matching circuits may be embedded in the wall 204.

As a non-limiting example, the accessory device 200-1 may (further) include a filter 303 for a signal received from the electronic device 170 within the receptacle 202 (e.g., the signal including the authentication request) and/or a signal transmitted to the electronic device 170 within the receptacle 202 (e.g., the signal including the authentication information). For example, the filter 303 may be used to transmit a signal on a frequency (or frequencies) within a reference frequency range through the antenna 224 and/or obtain a signal on the frequency (or the frequencies) within the reference frequency range, within the integrated circuitry 222-1 through the antenna 224. As a non-limiting example, the filter 303 may be embedded in the wall 204.

As described above, the accessory device 200-1 may include the antenna 224, which is a single antenna for supporting not only communication between the electronic device 170 within the receptacle 202 and the accessory device 200-1 but also communication between the electronic device 170 within the receptacle 202 and an external electronic device.

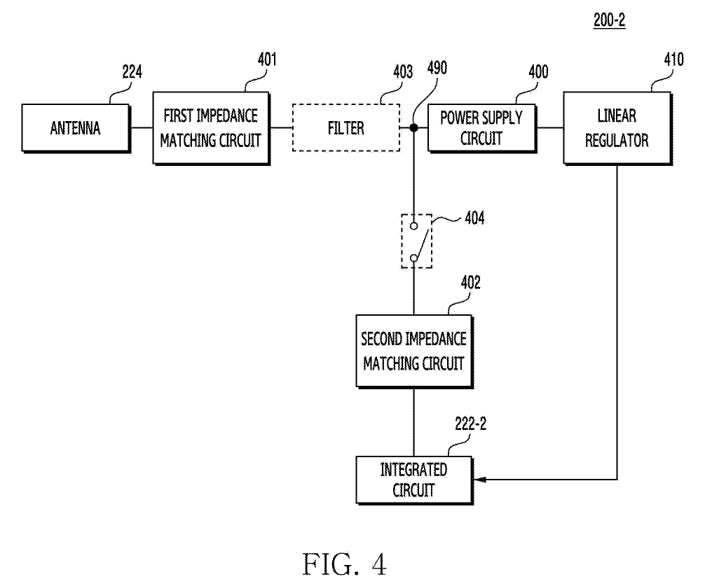

For example, since the antenna 224 is used for both communication between the electronic device 170 within the receptacle 202 and the accessory device 200-1 and communication between the electronic device 170 within the receptacle 202 and an external electronic device, one or more components (e.g., one or more impedance matching circuits and a switch) for shifting (or adjusting) (or changing) (or setting) a resonance frequency of the antenna 224 may be required. The one or more components are illustrated and described in greater detail below with reference to FIG. 4.

Referring to FIG. 4, the accessory device 200 may be implemented as an accessory device 200-2. According to an embodiment, the accessory device 200-2 may include an integrated circuit (e.g., including integrated circuitry) 222-2, an antenna 224, a power supply circuit (e.g., including power supply circuitry) 400, a first impedance matching circuit 401, a second impedance matching circuit 402, a switch 404, and a linear regulator (e.g., including circuitry) 410 (or low dropout (LDO) 410). As a non-limiting example, the power supply circuitry 400, the first impedance matching circuitry 401, the second impedance matching circuitry 402, the switch 404, and/or the linear regulator 410 may be embedded in the wall 204. As a non-limiting example, the linear regulator 410 may also be included in the power supply circuitry 400. For example, the power supply circuitry 400 may be connected to the antenna 224. For example, the integrated circuitry 222-2 may be connected to the antenna 224. For example, one or more nodes 490 connecting the antenna 224 to the power supply circuitry 400 may also be connected to the integrated circuitry 222-2. A path from the antenna 224 may be divided into a path to the power supply circuitry 400 and a path to the integrated circuitry 222-2, through the one or more nodes 490.

For example, the power supply circuitry 400 and the integrated circuitry of the integrated circuit 222-2 may be in parallel with the antenna 224.

The antenna 224 may be used for communication between the electronic device 170 within the receptacle 202 and the accessory device 200-2. The antenna 224 may be used to assist communication between the electronic device 170 within the receptacle 202 and an external electronic device.

For example, the communication between the electronic device 170 within the receptacle 202 and the accessory device 200-2 performed (or executed) through the antenna 224 may include exchange of the authentication request and the authentication information described above with reference to FIG. 2.

For example, the electronic device 170 positioned within the receptacle 202 may detect the target 226. As a non-limiting example, the electronic device 170 may detect the target 226, based on receiving (or sensing) (or identifying) an external magnetic field from the target 226, which is a magnet, using a magnetic field sensor of the electronic device 170. For example, the electronic device 170 may recognize (or identify) (or check) that the electronic device 170 is positioned within the receptacle 202, based on the detection.

For example, the electronic device 170 within the receptacle 202 may transmit one or more signals (or one or more RF signals) through an antenna of the electronic device 170 (e.g., an antenna of the electronic device 170 for NFC), based on the detection. As a non-limiting example, the one or more signals may be transmitted from the electronic device 170 according to the reader/writer mode among the modes for NFC. As a non-limiting example, the reader/writer mode may be triggered or initiated or activated, based on the detection.

For example, the one or more signals may be received through the antenna 224. As a non-limiting example, the one or more signals may include a signal including the authentication request to be described below. As a non-limiting example, the one or more signals may be received while the integrated circuitry 222-2 and the second impedance matching circuitry 402 are disconnected from the antenna 224 through the switch 404. For example, the one or more signals may be received through the antenna 224 connected to the first impedance matching circuitry 401 among the first impedance matching circuitry 401 and the second impedance matching circuitry 402. For example, the power supply circuitry 400 may obtain power from the one or more signals. For example, at least a portion of the power may be used for activation (or operation) of the integrated circuitry 222-2. For example, at least a portion of the power may be used for control of the switch 404. For example, at least a portion of the power may be provided to the integrated circuitry 222-2 through the linear regulator 410 from the power supply circuitry 400. For example, the integrated circuitry 222-2 may be activated or initiated or operated, using power provided through the linear regulator 410 from the power supply circuitry 400. For example, the activated integrated circuitry 222-2 may control the switch 404 using power provided through the linear regulator 410 from the power supply circuitry 400. For example, the switch 404 may (electrically) connect the second impedance matching circuitry 402 (or the second impedance matching circuitry 402 and the integrated circuitry 222-2) to the antenna 224, according to the control of the integrated circuitry 222-2. For example, the second impedance matching circuitry 402 may be connected to the antenna 224 through the first impedance matching circuitry 401 or connected to the antenna 224 through the first impedance matching circuitry 401 and the filter 403, according to a path formed by the switch 404 based on the control of the integrated circuitry 222-2.

For example, the electronic device 170 within the receptacle 202 may transmit the authentication request through an antenna of the electronic device 170 (e.g., an antenna of the electronic device 170 for NFC), based on the detection. As a non-limiting example, the electronic device 170 within the receptacle 202 may transmit a signal (or an RF signal) indicating the authentication request through the antenna of the electronic device 170, according to the reader/writer mode among the modes for NFC. As a non-limiting example, the reader/writer mode may be activated or initiated or triggered based on the detection.

For example, the integrated circuitry 222-2 may receive the authentication request from the electronic device 170 through the antenna 224 connected to the first impedance matching circuitry 401 and the second impedance matching circuitry 402. For example, the integrated circuitry 222-2 may transmit the authentication information through the antenna 224 connected to the first impedance matching circuitry 401 and the second impedance matching circuitry 402, in response to (or based on) the authentication request received through the antenna 224 connected to the first impedance matching circuitry 401 and the second impedance matching circuitry 402. As a non-limiting example, the authentication information may indicate a serial number of the accessory device 200-2, a color of the accessory device 200-2, and/or a material of the accessory device 200-2, or the authentication information may include data associated with a serial number of the accessory device 200-2, a color of the accessory device 200-2, and/or a material of the accessory device 200-2. As a non-limiting example, the authentication information may be (at least temporarily) stored in memory of the accessory device 200-2. For example, the integrated circuitry 222-2 may, in response to (or based on) receiving the authentication request through the antenna 224 connected to the first impedance matching circuitry 401 and the second impedance matching circuitry 402, obtain (or read) the authentication information from the memory within the accessory device 200-2, and transmit a signal including the obtained authentication information through the antenna 224 connected to the first impedance matching circuitry 401 and the second impedance matching circuitry 402. As a non-limiting example, the integrated circuitry 222-2 may transmit the authentication information through the antenna 224, using power obtained from the power supply circuitry 400 through the linear regulator 410. As a non-limiting example, the memory of the accessory device 200-2 may store instructions causing the integrated circuitry 222-2 to receive not only the authentication information but also the authentication request and to transmit the authentication information. As a non-limiting example, the instructions may be executed by the integrated circuitry 222-2 (or a processing circuitry (or a control circuit) within the integrated circuitry 222-2). As a non-limiting example, the memory of the accessory device 200-2 may be embedded in the receptacle 202. As a non-limiting example, the memory of the accessory device 200-2 may be included in the integrated circuitry 222-2 embedded in the receptacle 202.

For example, the electronic device 170 within the receptacle 202 may receive the authentication information through the antenna of the electronic device 170. As a non-limiting example, the electronic device 170 within the receptacle 202 may receive the authentication information through the antenna of the electronic device 170, according to the reader/writer mode. For example, the electronic device 170 may determine, according to the authentication information, whether the accessory device 200-2 is made by a manufacturer of the electronic device 170 and/or an approved third-party accessory device manufacturer. As a non-limiting example, the electronic device 170 may recognize that the accessory device 200-2 is made by a manufacturer of the electronic device 170 and/or an approved third-party accessory device manufacturer, according to the authentication information.

For example, the integrated circuitry 222-2 may control the switch 404 to disconnect the second impedance matching circuitry 402 from the antenna 224 (or disconnect the second impedance matching circuitry 402 and the integrated circuitry 222-2 from the antenna 224), based on transmitting the authentication information. For example, the integrated circuitry 222-2 may execute the control of the switch 404, using power obtained from the power supply circuitry 400 through the linear regulator 410.

For example, the antenna 224 used for the communication between the electronic device 170 within the receptacle 202 and the accessory device 200-2 may be further used to assist communication between the electronic device 170 within the receptacle 202 and the external electronic device, while being disconnected from the second impedance matching circuitry 402 according to the control of the switch 404. For example, the electronic device 170 within the receptacle 202 may transmit a signal to the external electronic device that is at least partially adjacent to or contacted with another surface of the wall 204 opposite to a surface of the wall 204 at least partially contacted with the electronic device 170 within the receptacle 202. As a non-limiting example, the signal may be transmitted from the electronic device 170, according to a card emulation mode among the modes for NFC. For example, the signal may be transmitted to the external electronic device through the antenna of the electronic device 170 and the antenna 224, which is coupled with the antenna of the electronic device 170 and is electrically connected to the first impedance matching circuitry 401 among the first impedance matching circuitry 401 and the second impedance matching circuitry 402. For example, the signal radiated from the antenna of the electronic device 170 may be boosted by the antenna 224 coupled with the antenna of the electronic device 170 and connected to the first impedance matching circuitry 401 among the first impedance matching circuitry 401 and the second impedance matching circuitry 402. For example, the antenna 224 connected to the first impedance matching circuitry 401 among the first impedance matching circuitry 401 and the second impedance matching circuitry 402 may be coupled with the antenna of the electronic device 170 within the receptacle 202 such that the signal transmitted from the electronic device 170 within the receptacle 202 has enhanced reception quality within the external electronic device.

As a non-limiting example, a transmission frequency of the signal transmitted to the external electronic device through the antenna of the electronic device 170 and the antenna 224 while the electronic device 170 is positioned within the receptacle 202 may correspond to a transmission frequency of the signal transmitted to the external electronic device through only the antenna of the electronic device 170 while the electronic device 170 is positioned outside the receptacle 202. For example, since the antenna 224 is disconnected from the second impedance matching circuitry 402 through the switch 404 after the authentication information is transmitted, a transmission frequency of the signal transmitted to the external electronic device through the antenna of the electronic device 170 and the antenna 224 while the electronic device 170 is positioned within the receptacle 202 may be substantially the same as a transmission frequency of the signal transmitted to the external electronic device through only the antenna of the electronic device 170 while the electronic device 170 is positioned outside the receptacle 202. For example, the second impedance matching circuitry 402 may be connected to the antenna 224 by the switch 404 for a transmission frequency of a signal, including the authentication information, transmitted through the antenna 224.

As a non-limiting example, a transmission frequency of a signal transmitted to the external electronic device from the electronic device 170 through the antenna of the electronic device 170 and the antenna 224 coupled with the antenna of the electronic device 170 may correspond to a transmission frequency of a signal (e.g., the signal including the authentication information) transmitted to the electronic device 170 from the accessory device 200-2 through the antenna 224. As a non-limiting example, since a resonance frequency of the antenna 224 connected to the first impedance matching circuitry 401 among the first impedance matching circuitry 401 and the second impedance matching circuitry 402 is different from a resonance frequency of the antenna 224 connected to both the first impedance matching circuitry 401 and the second impedance matching circuitry 402, a transmission frequency of a signal transmitted to the external electronic device from the electronic device 170 through the antenna of the electronic device 170 and the antenna 224 coupled with the antenna of the electronic device 170 and a transmission frequency of a signal (e.g., the signal including the authentication information) transmitted to the electronic device 170 from the accessory device 200-2 through the antenna 224 may be substantially about 13.56 (MHz). As a non-limiting example, a resonance frequency of the antenna 224 connected to the first impedance matching circuitry 401 among the first impedance matching circuitry 401 and the second impedance matching circuitry 402 or connected to both the first impedance matching circuitry 401 and the second impedance matching circuitry 402 may be slightly (or marginally) higher than 13.56 (MHz). As a non-limiting example, the resonance frequency may be about 14 (MHz).

As a non-limiting example, the signal transmitted to the external electronic device through the antenna of the electronic device 170 and the antenna 224 while the electronic device 170 is positioned within the receptacle 202 may be transmitted in response to another signal transmitted to the electronic device 170 within the receptacle 202 from the external electronic device. For example, the another signal may be received from the external electronic device through the antenna 224 connected to the first impedance matching circuitry 401 among the first impedance matching circuitry 401 and the second impedance matching circuitry 402 and the antenna of the electronic device 170 within the receptacle 202. As a non-limiting example, the another signal may be boosted by the antenna 224 coupled with the antenna of the electronic device 170 within the receptacle 202 and connected to the first impedance matching circuitry 401 among the first impedance matching circuitry 401 and the second impedance matching circuitry 402. For example, the antenna 224 connected to the first impedance matching circuitry 401 among the first impedance matching circuitry 401 and the second impedance matching circuitry 402 may be coupled with the antenna of the electronic device 170 within the receptacle 202 such that the signal transmitted to the electronic device 170 within the receptacle 202 from the external electronic device has enhanced reception quality within the electronic device 170 within the receptacle 202.

As a non-limiting example, the accessory device 200-2 may further include a filter 403 for a signal received from the electronic device 170 within the receptacle 202 (e.g., the signal including the authentication request) and/or a signal transmitted to the electronic device 170 within the receptacle 202 (e.g., the signal including the authentication information). For example, the filter 403 may be used to transmit a signal on a frequency (or frequencies) within a reference frequency range through the antenna 224 connected to the first impedance matching circuitry 401 and the second impedance matching circuitry 402 and/or to obtain, within the integrated circuitry 222-2, a signal on the frequency (or the frequencies) within the reference frequency range through the antenna 224 connected to the first impedance matching circuitry 401 and the second impedance matching circuitry 402. As a non-limiting example, the filter 403 may be embedded in the wall 204.

FIG. 4 illustrates the accessory device 200-2 including two impedance matching circuits (e.g., the first impedance matching circuitry 401 and the second impedance matching circuitry 402), but this is only an example. The accessory device 200-2 may also include one impedance matching circuitry (e.g., the second impedance matching circuitry 402) connected to the antenna 224 or disconnected from the antenna 224.

As described above, the accessory device 200-2 according to an embodiment may include the antenna 224, which is a single antenna for supporting not only communication between the electronic device 170 within the receptacle 202 and the accessory device 200-2 but also communication between the electronic device 170 within the receptacle 202 and an external electronic device. For example, the accessory device 200-2 may include one or more impedance matching circuits (e.g., the second impedance matching circuitry 402) connected to the antenna 224 or disconnected from the antenna 224 to adjust a resonance frequency of the antenna 224, according to a function (e.g., communication between the electronic device 170 within the receptacle 202 and the accessory device 200-2 or communication between the electronic device 170 within the receptacle 202 and an external electronic device) supported by the antenna 224.

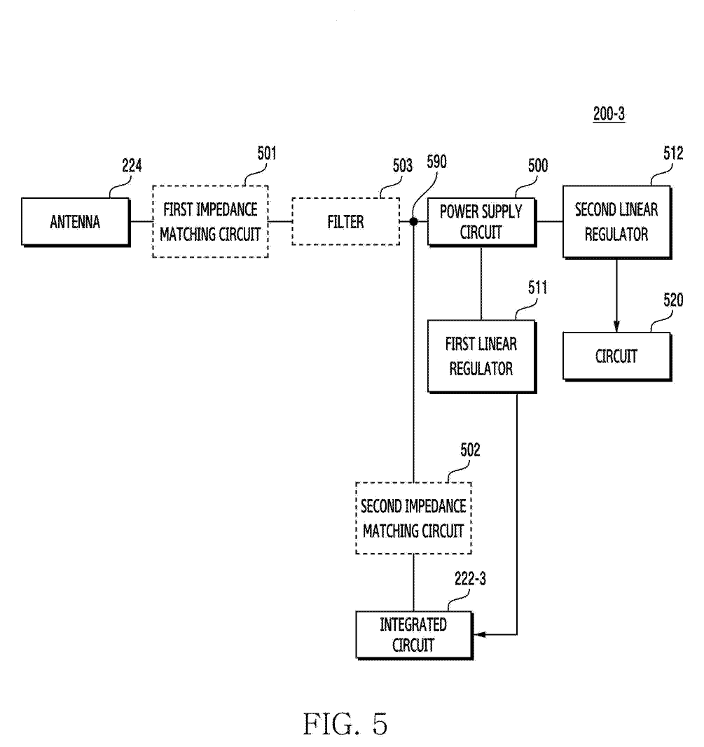

For example, the accessory device 200 illustrated in FIG. 2 may further include a circuitry usable to provide information, such as the display 220. For example, the antenna 224 within the accessory device 200 further including the circuitry may further include one or more components (e.g., a linear regulator associated with the circuit) for providing power to the circuitry as well as communication between the electronic device 170 within the receptacle 202 and the accessory device 200 and communication between the electronic device 170 within the receptacle 202 and an external electronic device. The accessory device 200 is described in greater detail below with reference to FIG. 5.

Referring to FIG. 5, the accessory device 200 may be implemented as an accessory device 200-3. The accessory device 200-3 according to an embodiment may include an integrated circuit (e.g., including integrated circuitry) 222-3, an antenna 224, a power supply (e.g., including power supply circuitry)_ 500 (e.g., corresponding to the power supply circuitry 400 of FIG. 4), a first linear regulator (e.g., including circuitry) 511 (or a first LDO 511) (e.g., corresponding to the linear regulator 410 of FIG. 4), a second linear regulator (e.g., including circuitry) 512 (or a second LDO 512), and a circuitry 520 usable to provide information. According to an implementation, the first linear regulator 511 and/or the second linear regulator 512 may be omitted from the accessory device 200-3. For example, the power supply circuitry 500 may be connected to the antenna 224. For example, the integrated circuitry 222-3 may be connected to the antenna 224. For example, one or more nodes 590 connecting the antenna 224 to the power supply circuitry 500 may also be connected to the integrated circuitry 222-3. A path from the antenna 224 may be divided into a path to the power supply circuitry 500 and a path to the integrated circuitry 222-3, through the one or more nodes 590. For example, the power supply circuitry 500 and the integrated circuitry 222-3 may be in parallel with the antenna 224.

The antenna 224 may be used for communication between the electronic device 170 within the receptacle 202 and the accessory device 200-3. For example, the antenna 224 may be used to assist communication between the electronic device 170 within the receptacle 202 and an external electronic device. For example, the antenna 224 may be used to obtain, from the electronic device 170 within the receptacle 202, power for the circuitry 520 usable to provide the information.

For example, the communication between the electronic device 170 within the receptacle 202 and the accessory device 200-3 performed (or executed) through the antenna 224 may include exchange of the authentication request and the authentication information described above with reference to FIG. 2.

For example, the electronic device 170 positioned within the receptacle 202 may detect the target 226. As a non-limiting example, the electronic device 170 may detect the target 226, based on receiving (or sensing) (or identifying) an external magnetic field from the target 226, which is a magnet, using a magnetic field sensor of the electronic device 170. For example, the electronic device 170 may recognize (or identify) (or check) that the electronic device 170 is positioned within the receptacle 202, based on the detection.

For example, the electronic device 170 within the receptacle 202 may transmit one or more signals (or one or more RF signals) through an antenna of the electronic device 170 (e.g., an antenna of the electronic device 170 for NFC), based on the detection. As a non-limiting example, the one or more signals may be transmitted from the electronic device 170, according to the reader/writer mode among the modes for NFC. As a non-limiting example, the reader/writer mode may be triggered or initiated or activated, based on the detection.

For example, the one or more signals may be received through the antenna 224. As a non-limiting example, the one or more signals may include a signal including the authentication request to be described below. For example, the power supply circuitry 500 may obtain power from the one or more signals. For example, at least a portion of the power may be used for activation (or operation) (or trigger) (or initiation) of the integrated circuitry 222-3. For example, at least a portion of the power may be provided to the integrated circuitry 222-3 through the first linear regulator 511 from the power supply circuitry 500. For example, the integrated circuitry 222-3 may be activated or initiated or operated or triggered, using power provided through the first linear regulator 511 from the power supply circuitry 500.

For example, the electronic device 170 within the receptacle 202 may transmit the authentication request through an antenna of the electronic device 170 (e.g., an antenna of the electronic device 170 for NFC), based on the detection. As a non-limiting example, the electronic device 170 within the receptacle 202 may transmit a signal (or an RF signal) indicating the authentication request through the antenna of the electronic device 170, according to the reader/writer mode among the modes for NFC. As a non-limiting example, the reader/writer mode may be activated (or initiated) (or triggered), based on the detection.

For example, the integrated circuitry 222-3 may receive the authentication request from the electronic device 170 through the antenna 224. For example, the integrated circuitry 222-3 may receive, through the antenna 224 using a wireless communication circuitry within the integrated circuitry 222-3, the authentication request transmitted based on detecting the target 226 from the electronic device 170 positioned within the receptacle 202, according to first power obtained through the first linear regulator 511 from the power supply circuitry 500. For example, the integrated circuitry 222-3 may transmit the authentication information through the antenna 224 using the wireless communication circuit, in response to (or based on) the authentication request received through the antenna 224, according to the first power obtained through the first linear regulator 511 from the power supply circuitry 500. As a non-limiting example, the authentication information may indicate a serial number of the accessory device 200-3, a color of the accessory device 200-3, and/or a material of the accessory device 200-3, or the authentication information may include data associated with a serial number of the accessory device 200-3, a color of the accessory device 200-3, and/or a material of the accessory device 200-3. As a non-limiting example, the authentication information may be (at least temporarily) stored, in memory of the accessory device 200-3. For example, the integrated circuitry 222-3 may, in response to (or based on) receiving the authentication request through the antenna 224, obtain (or read) the authentication information from the memory within the accessory device 200-3, and transmit a signal including the obtained authentication information through the antenna 224. As a non-limiting example, the integrated circuitry 222-3 may transmit the authentication information through the antenna 224 using the first power obtained through the first linear regulator 511 from the power supply circuitry 500. As a non-limiting example, the memory of the accessory device 200-3 may store instructions causing the integrated circuitry 222-3 to receive not only the authentication information but also the authentication request and to transmit the authentication information. As a non-limiting example, the instructions may be executed by the integrated circuitry 222-3 (or a processing circuitry (or a control circuit) within the integrated circuitry 222-3). As a non-limiting example, the memory of the accessory device 200-3 may be embedded in the receptacle 202. As a non-limiting example, the memory of the accessory device 200-3 may be included in the integrated circuitry 222-3 embedded in the receptacle 202.

As a non-limiting example, a transmission frequency of a signal transmitted through the antenna 224 of the accessory device 200-3 (e.g., the signal including the authentication information) may be shifted from a transmission frequency of another signal transmitted through the antenna of the electronic device 170 positioned outside the receptacle 202.

For example, the electronic device 170 within the receptacle 202 may receive the authentication information through the antenna of the electronic device 170. As a non-limiting example, the electronic device 170 within the receptacle 202 may receive the authentication information through the antenna of the electronic device 170, according to the reader/writer mode. For example, the electronic device 170 may determine, according to the authentication information, whether the accessory device 200-3 is made by a manufacturer of the electronic device 170 and/or an approved third-party accessory device manufacturer. As a non-limiting example, the electronic device 170 may recognize that the accessory device 200-3 is made by a manufacturer of the electronic device 170 and/or an approved third-party accessory device manufacturer, according to the authentication information.

For example, the antenna 224 used for the communication between the electronic device 170 within the receptacle 202 and the accessory device 200-3 may be further used to provide power to the circuitry 520. For example, the circuitry 520 may obtain second power through the second linear regulator 512 from the power supply circuitry 500 obtaining power using a signal (e.g., the one or more signals) received through the antenna 224 from the electronic device 170 within the receptacle 202. The second power may be provided to the circuitry 520 to provide the information. For example, the second power may be different from the first power. As a non-limiting example, the second power may be greater than the first power. For example, the circuitry 520 may provide the information using the second power. As a non-limiting example, the circuitry 520 obtaining the second power may be controlled by the integrated circuitry 222-3 performed according to the first power to provide the information. As a non-limiting example, the memory within the accessory device 200-3 (or the memory within the integrated circuitry 222-3) (or the memory embedded in the wall 204) may (at least temporarily) store instructions causing the integrated circuitry 222-3 to control the circuitry 520 to provide the information. For example, the instructions may be executed by the integrated circuitry 222-3 (or a processing circuitry within the integrated circuitry 222-3).

The circuitry 520 may be implemented variously.

For example, the circuitry 520 may include the display 220 of FIG. 2 or may be associated with the display 220 or may be connected to the display 220. For example, the circuitry 520 including the display 220 (or the circuitry 520 associated with the display 220) (or the circuitry 520 connected to the display 220) may provide the information, by displaying the information on the display 220 using the second power. As a non-limiting example, the circuitry 520 including the display 220 (or the circuitry 520 associated with the display 220) (or the circuitry 520 connected to the display 220) may be embedded in the cover 214. For example, a path for the second power from the power supply circuitry 500 may extend to the circuitry 520 embedded in the cover 214 across the hinge 218. For example, the information provided through the circuitry 520 may be displayed through the display 220 on a second surface opposite to a first surface of the cover 214 at least partially contacting with the electronic device 170 within the receptacle 202, using the second power.

For example, the circuitry 520 may include one or more circuits for outputting sound (e.g., including a speaker) or may be associated with the one or more circuits or may be connected to the one or more circuits. For example, the circuitry 520 including the one or more circuits (or the circuitry 520 associated with the one or more circuits) (or the circuitry 520 connected to the one or more circuits) may provide the information by outputting sound using the second power.

For example, the antenna 224 used to perform (or execute) the communication between the electronic device 170 within the receptacle 202 and the accessory device 200-3 and used to obtain power for outputting (or providing) the information through the circuitry 520 may be further used to assist communication between the electronic device 170 within the receptacle 202 and an external electronic device. For example, the electronic device 170 within the receptacle 202 may transmit a signal to the external electronic device at least partially adjacent to or contacted to another surface of the wall 204 opposite to a surface of the wall 204 at least partially contacted to the electronic device 170 within the receptacle 202. As a non-limiting example, the signal may be transmitted from the electronic device 170, according to a card emulation mode among the modes for NFC. For example, the signal may be transmitted to the external electronic device through the antenna of the electronic device 170 and the antenna 224 coupled with the antenna of the electronic device 170. For example, the signal radiated from the antenna of the electronic device 170 may be boosted by the antenna 224 coupled with the antenna of the electronic device 170. For example, the antenna 224 may be coupled with the antenna of the electronic device 170 such that the signal transmitted from the electronic device 170 within the receptacle 202 has enhanced reception quality within the external electronic device.

As a non-limiting example, a transmission frequency of the signal transmitted to the external electronic device through the antenna of the electronic device 170 and the antenna 224 while the electronic device 170 is positioned within the receptacle 202 may be shifted from a transmission frequency of the signal transmitted to the external electronic device through only the antenna of the electronic device 170 while the electronic device 170 is positioned outside the receptacle 202.

As a non-limiting example, the transmission frequency of the signal transmitted to the external electronic device through the antenna of the electronic device 170 and the antenna 224 while the electronic device 170 is positioned within the receptacle 202 may be about 14 (MHz) shifted from about 13.56 (MHz), which is a transmission frequency of the signal transmitted through the antenna of the electronic device 170 while the electronic device 170 is positioned outside the receptacle 202. As a non-limiting example, a resonance frequency of the antenna 224 may be slightly (or marginally) higher than 13.56 (MHz). For example, the resonance frequency may be about 14 (MHz).

As a non-limiting example, the transmission frequency of the signal transmitted to the external electronic device through the antenna of the electronic device 170 and the antenna 224 while the electronic device 170 is positioned within the receptacle 202 may also be about 13.56 (MHz), which is a transmission frequency of the signal transmitted through the antenna of the electronic device 170 while the electronic device 170 is positioned outside the receptacle 202. As a non-limiting example, the electronic device 170 within the receptacle 202 may, based on detection of the target 226, obtain the signal on another transmission frequency (e.g., about 14 (MHz)) shifted from a transmission frequency (e.g., about 13.56 (MHz)) of the signal transmitted to the external electronic device from the electronic device 170 positioned outside the receptacle 202, and may transmit the signal on the another transmission frequency through the antenna of the electronic device 170. As a non-limiting example, the signal on the another transmission frequency may be obtained based on the detection and the authentication information. For example, the another transmission frequency (e.g., about 14 (MHz)) of the signal transmitted to the external electronic device may be shifted to the transmission frequency (e.g., about 13.56 (MHz)) by the antenna 224. For example, the transmission frequency of the signal transmitted through the antenna of the electronic device 170 within the receptacle 202 and the antenna 224 may be substantially the same as a transmission frequency of the signal transmitted through the antenna of the electronic device 170 outside the receptacle 202. For example, the electronic device 170 may (at least temporarily) store instructions for operations for shifting described above, in the memory of the electronic device 170. The instructions may be executed by a processing circuitry (e.g., the processor 720 of FIG. 7) of the electronic device 170.

As a non-limiting example, the signal transmitted to the external electronic device through the antenna of the electronic device 170 and the antenna 224 while the electronic device 170 is positioned within the receptacle 202 may be transmitted, in response to another signal transmitted to the electronic device 170 within the receptacle 202 from the external electronic device. For example, the another signal may be received from the external electronic device through the antenna 224 and the antenna of the electronic device 170 within the receptacle 202. As a non-limiting example, the another signal may be boosted by the antenna 224 coupled with the antenna of the electronic device 170 within the receptacle 202. For example, the antenna 224 may be coupled with the antenna of the electronic device 170 within the receptacle 202 such that the signal transmitted to the electronic device 170 within the receptacle 202 from the external electronic device has enhanced reception quality within the electronic device 170 within the receptacle 202.

As a non-limiting example, the accessory device 200-3 may (further) include one or more impedance matching circuits connected to the antenna 224 to set a resonance frequency of the antenna 224 (or a transmission frequency of a signal transmitted through the antenna 224). For example, the accessory device 200-3 may include, as the one or more impedance matching circuits, a first impedance matching circuitry 501 connected to the antenna 224 and a second impedance matching circuitry 502 connected to the antenna 224 through the first impedance matching circuitry 501. As a non-limiting example, the one or more impedance matching circuits may be embedded in the wall 204.

As a non-limiting example, the accessory device 200-3 may (further) include a filter 503 for a signal received from the electronic device 170 within the receptacle 202 (e.g., the signal including the authentication request) and/or a signal transmitted to the electronic device 170 within the receptacle 202 (e.g., the signal including the authentication information). For example, the filter 503 may be used to transmit a signal on a frequency (or frequencies) within a reference frequency range through the antenna 224 and/or obtain, within the integrated circuitry 222-3, a signal on the frequency (or the frequencies) within the reference frequency range through the antenna 224. As a non-limiting example, the filter 503 may be embedded in the wall 204.

As described above, the accessory device 200-3 may include the antenna 224, which is a single antenna for supporting performing communication between the electronic device 170 within the receptacle 202 and the accessory device 200-3, performing communication between the electronic device 170 within the receptacle 202 and an external electronic device, and providing power for providing information to the circuitry 520.

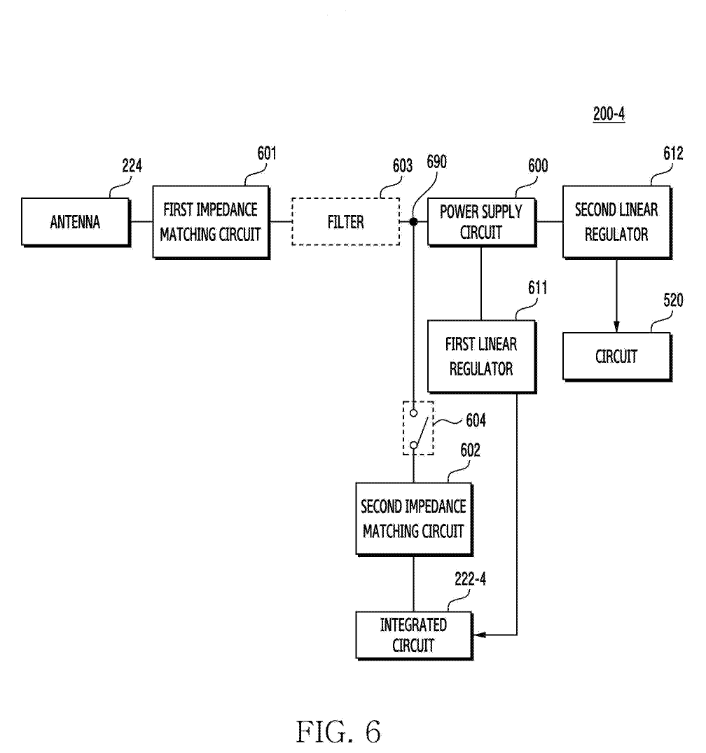

For example, since the antenna 224 is used for all of performing communication between the electronic device 170 within the receptacle 202 and the accessory device 200-3, performing communication between the electronic device 170 within the receptacle 202 and an external electronic device, and providing power for providing information to the circuitry 520, one or more components (e.g., one or more impedance matching circuits and a switch) for shifting (or adjusting) (or changing) (or setting) a resonance frequency of the antenna 224 may be required. The one or more components are described in greater detail below with reference to FIG. 6.

Referring to FIG. 6, the accessory device 200 may be implemented as an accessory device 200-4. The accessory device 200-4 may include an integrated circuit (e.g., including integrated circuitry) 222-4, an antenna 224, a power supply (e.g., including power supply circuitry) 600 (e.g., corresponding to the power supply circuitry 500 of FIG. 5), a first impedance matching circuit 601 (e.g., corresponding to the first impedance matching circuitry 401 of FIG. 4), a second impedance matching circuit 602 (e.g., corresponding to the second impedance matching circuitry 402 of FIG. 4), a switch 604 (e.g., corresponding to the switch 404 of FIG. 4), a first linear regulator (e.g., including circuitry) 611 (or a first LDO 611) (e.g., corresponding to the first linear regulator 511 of FIG. 5), a second linear regulator (e.g., including circuitry) 612 (or a second LDO 612) (e.g., corresponding to the second linear regulator 512 of FIG. 5), and a circuit (e.g., including various circuitry) 520. As a non-limiting example, the power supply circuitry 600, the first impedance matching circuitry 601, the second impedance matching circuitry 602, the switch 604, the first linear regulator 611, the second linear regulator 612, and/or the circuitry 520 may be embedded in the wall 204. According to an implementation, the first linear regulator 611 and/or the second linear regulator 612 may be omitted from the accessory device 200-4. As a non-limiting example, the circuitry 520 may also be embedded in the cover 214. For example, the power supply circuitry 600 may be connected to the antenna 224. For example, one or more nodes 690 connecting the antenna 224 to the power supply circuitry 600 may also be connected to the integrated circuitry 222-4. A path from the antenna 224 may be divided into a path to the power supply circuitry 600 and a path to the integrated circuitry 222-4, through the one or more nodes 690. For example, the power supply circuitry 600 and the integrated circuitry 222-4 may be in parallel with the antenna 224.

The antenna 224 may be used for communication between the electronic device 170 within the receptacle 202 and the accessory device 200-4. The antenna 224 may be used to assist communication between the electronic device 170 within the receptacle 202 and an external electronic device. The antenna 224 may be used to obtain, from the electronic device 170 within the receptacle 202, power for the circuitry 520 usable to provide the information.

For example, the communication between the electronic device 170 within the receptacle 202 and the accessory device 200-4 performed (or executed) through the antenna 224 may include exchange of the authentication request and the authentication information described above with reference to FIG. 2.

For example, the electronic device 170 positioned within the receptacle 202 may detect the target 226. As a non-limiting example, the electronic device 170 may detect the target 226, based on receiving (or sensing) (or identifying) an external magnetic field from the target 226, which is a magnet, using a magnetic field sensor of the electronic device 170. For example, the electronic device 170 may recognize (or identify) (or check) that the electronic device 170 is positioned within the receptacle 202, based on the detection.

For example, the electronic device 170 within the receptacle 202 may transmit one or more signals (or one or more RF signals) through an antenna of the electronic device 170 (e.g., an antenna of the electronic device 170 for NFC), based on the detection. As a non-limiting example, the one or more signals may be transmitted from the electronic device 170 according to the reader/writer mode among the modes for NFC. As a non-limiting example, the reader/writer mode may be triggered or initiated or activated, based on the detection.

For example, the one or more signals may be received through the antenna 224. As a non-limiting example, the one or more signals may include a signal including the authentication request to be described in greater detail below. As a non-limiting example, the one or more signals may be received while the integrated circuitry 222-4 and the second impedance matching circuitry 602 are disconnected from the antenna 224 through the switch 604. For example, the one or more signals may be received through the antenna 224 connected to the first impedance matching circuitry 601 among the first impedance matching circuitry 601 and the second impedance matching circuitry 602. For example, the power supply circuitry 600 may obtain power from the one or more signals. For example, at least a portion of the power may be used for activation (or operation) of the integrated circuitry 222-4. For example, at least a portion of the power may be used for control of the switch 604. For example, at least a portion of the power may be provided to the integrated circuitry 222-4 through the first linear regulator 611 from the power supply circuitry 600. For example, the integrated circuitry 222-4 may be activated or initiated or operated using first power provided through the first linear regulator 611 from the power supply circuitry 600. For example, the activated integrated circuitry 222-4 may control the switch 604 using the first power provided through the first linear regulator 611 from the power supply circuitry 600. For example, the switch 604 may electrically connect the second impedance matching circuitry 602 (or the second impedance matching circuitry 602 and the integrated circuitry 222-4) to the antenna 224, according to the control of the integrated circuitry 222-4. For example, the second impedance matching circuitry 602 may be electrically connected to the antenna 224 through the first impedance matching circuitry 601 or electrically connected to the antenna 224 through the first impedance matching circuitry 601 and the filter 603, according to a path formed by the switch 604 based on the control of the integrated circuitry 222-4.

For example, the electronic device 170 within the receptacle 202 may transmit the authentication request through an antenna of the electronic device 170 (e.g., an antenna of the electronic device 170 for NFC), based on the detection. As a non-limiting example, the electronic device 170 within the receptacle 202 may transmit a signal (or an RF signal) indicating the authentication request through the antenna of the electronic device 170, according to the reader/writer mode among the modes for NFC. As a non-limiting example, the reader/writer mode may be activated or initiated or triggered, based on the detection.

For example, the integrated circuitry 222-4 may receive, from the electronic device 170 through the antenna 224 connected to the first impedance matching circuitry 601 and the second impedance matching circuitry 602, the authentication request using a wireless communication circuitry within the integrated circuitry 222-4. For example, the integrated circuitry 222-4 may transmit, through the antenna 224 connected to the first impedance matching circuitry 601 and the second impedance matching circuitry 602, the authentication information using the wireless communication circuit, in response to (or based on) the authentication request received through the antenna 224 connected to the first impedance matching circuitry 601 and the second impedance matching circuitry 602. As a non-limiting example, the authentication information may indicate a serial number of the accessory device 200-4, a color of the accessory device 200-4, and/or a material of the accessory device 200-4, or the authentication information may include data associated with a serial number of the accessory device 200-4, a color of the accessory device 200-4, and/or a material of the accessory device 200-4. As a non-limiting example, the authentication information may be (at least temporarily) stored, in memory of the accessory device 200-4. For example, the integrated circuitry 222-4 may, in response to (or based on) receiving the authentication request through the antenna 224 connected to the first impedance matching circuitry 601 and the second impedance matching circuitry 602, obtain (or read) the authentication information from the memory within the accessory device 200-4, and transmit a signal including the obtained authentication information through the antenna 224 connected to the first impedance matching circuitry 601 and the second impedance matching circuitry 602. As a non-limiting example, the integrated circuitry 222-4 may transmit the authentication information through the antenna 224, using the first power obtained through the first linear regulator 611 from the power supply circuitry 600. As a non-limiting example, the memory of the accessory device 200-4 may store instructions causing the integrated circuitry 222-4 to receive not only the authentication information but also the authentication request and to transmit the authentication information. As a non-limiting example, the instructions may be executed by the integrated circuitry 222-4 (or a processing circuitry (or a control circuit) within the integrated circuitry 222-4). As a non-limiting example, the memory of the accessory device 200-4 may be embedded in the receptacle 202. As a non-limiting example, the memory of the accessory device 200-4 may be included in the integrated circuitry 222-4 embedded in the receptacle 202.

For example, the electronic device 170 within the receptacle 202 may receive the authentication information through the antenna of the electronic device 170. As a non-limiting example, the electronic device 170 within the receptacle 202 may receive the authentication information through the antenna of the electronic device 170, according to the reader/writer mode. For example, the electronic device 170 may determine, according to the authentication information, whether the accessory device 200-4 is made by a manufacturer of the electronic device 170 and/or an approved third-party accessory device manufacturer. As a non-limiting example, the electronic device 170 may recognize that the accessory device 200-4 is made by a manufacturer of the electronic device 170 and/or an approved third-party accessory device manufacturer, according to the authentication information.

For example, the integrated circuitry 222-4 may control the switch 604 to disconnect the second impedance matching circuitry 602 from the antenna 224 (or disconnect the second impedance matching circuitry 602 and the integrated circuitry 222-4 from the antenna 224), based on transmitting the authentication information. For example, the integrated circuitry 222-4 may execute the control of the switch 604 using the first power obtained through the first linear regulator 611 from the power supply circuitry 600.

For example, the antenna 224 used for the communication between the electronic device 170 within the receptacle 202 and the accessory device 200-4 may be further used to provide power to the circuitry 520. For example, the circuitry 520 may obtain second power through the second linear regulator 612 from the power supply circuitry 600 obtaining power using a signal (e.g., the one or more signals) received through the antenna 224 from the electronic device 170 within the receptacle 202. The second power may be provided to the circuitry 520 to provide the information. For example, the second power may be different from the first power. As a non-limiting example, the second power may be greater than the first power. For example, the circuitry 520 may provide the information using the second power. As a non-limiting example, the circuitry 520 obtaining the second power may be controlled by the integrated circuitry 222-4 performed according to the first power to provide the information. As a non-limiting example, the memory within the accessory device 200-4 (or the memory within the integrated circuitry 222-4) (or the memory embedded in the wall 204) may (at least temporarily) store instructions causing the integrated circuitry 222-4 to control the circuitry 520 to provide the information. For example, the instructions may be executed by the integrated circuitry 222-4 (or a processing circuitry within the integrated circuitry 222-4).

The circuitry 520 may be implemented variously.

For example, the circuitry 520 may include the display 220 of FIG. 2 or may be associated with the display 220 or may be connected to the display 220. For example, the circuitry 520 including the display 220 (or the circuitry 520 associated with the display 220) (or the circuitry 520 connected to the display 220) may provide the information, by displaying the information on the display 220 using the second power. As a non-limiting example, the circuitry 520 including the display 220 (or the circuitry 520 associated with the display 220) (or the circuitry 520 connected to the display 220) may be embedded in the cover 214. For example, a path for the second power from the power supply circuitry 500 may extend to the circuitry 520 embedded in the cover 214 across the hinge 218. For example, the information provided through the circuitry 520 may be displayed through the display 220 on a second surface opposite to a first surface of the cover 214 at least partially contacted with the electronic device 170 within the receptacle 202, using the second power.

For example, the circuitry 520 may include one or more circuits for outputting sound (e.g., including a speaker) or may be associated with the one or more circuits or may be connected to the one or more circuits. For example, the circuitry 520 including the one or more circuits (or the circuitry 520 associated with the one or more circuits) (or the circuitry 520 connected to the one or more circuits) may provide the information by outputting sound using the second power.

For example, the antenna 224 used to perform (or execute) the communication between the electronic device 170 within the receptacle 202 and the accessory device 200-4 and used to obtain power for outputting (or providing) the information through the circuitry 520 may be further used to assist communication between the electronic device 170 within the receptacle 202 and an external electronic device while being disconnected from the second impedance matching circuitry 602 according to the control of the switch 604. For example, the electronic device 170 within the receptacle 202 may transmit a signal to the external electronic device at least partially contacted to another surface of the wall 204 opposite to a surface of the wall 204 at least partially contacted to the electronic device 170 within the receptacle 202. As a non-limiting example, the signal may be transmitted from the electronic device 170, according to a card emulation mode among the modes for NFC. For example, the signal may be transmitted to the external electronic device through the antenna of the electronic device 170 and the antenna 224 coupled with the antenna of the electronic device 170 and connected to the first impedance matching circuitry 601 among the first impedance matching circuitry 601 and the second impedance matching circuitry 602. For example, the signal radiated from the antenna of the electronic device 170 may be boosted by the antenna 224 coupled with the antenna of the electronic device 170 and connected to the first impedance matching circuitry 601 among the first impedance matching circuitry 601 and the second impedance matching circuitry 602. For example, the antenna 224 connected to the first impedance matching circuitry 601 among the first impedance matching circuitry 601 and the second impedance matching circuitry 602 may be coupled with the antenna of the electronic device 170 within the receptacle 202 such that the signal transmitted from the electronic device 170 within the receptacle 202 has enhanced reception quality within the external electronic device.

As a non-limiting example, a transmission frequency of the signal transmitted to the external electronic device through the antenna of the electronic device 170 and the antenna 224 while the electronic device 170 is positioned within the receptacle 202 may correspond to a transmission frequency of the signal transmitted to the external electronic device through only the antenna of the electronic device 170 while the electronic device 170 is positioned outside the receptacle 202. For example, since the antenna 224 is disconnected from the second impedance matching circuitry 602 through the switch 604 after the authentication information is transmitted, a transmission frequency of the signal transmitted to the external electronic device through the antenna of the electronic device 170 and the antenna 224 while the electronic device 170 is positioned within the receptacle 202 may be substantially the same as a transmission frequency of the signal transmitted to the external electronic device through only the antenna of the electronic device 170 while the electronic device 170 is positioned outside the receptacle 202.

As a non-limiting example, a transmission frequency of a signal transmitted to the external electronic device from the electronic device 170 through the antenna of the electronic device 170 and the antenna 224 coupled with the antenna of the electronic device 170 may correspond to a transmission frequency of a signal (e.g., the signal including the authentication information) transmitted to the electronic device 170 from the accessory device 200-4 through the antenna 224. As a non-limiting example, since a resonance frequency of the antenna 224 connected to the first impedance matching circuitry 601 among the first impedance matching circuitry 601 and the second impedance matching circuitry 602 is different from a resonance frequency of the antenna 224 connected to both the first impedance matching circuitry 601 and the second impedance matching circuitry 602, the transmission frequency of the signal transmitted to the external electronic device from the electronic device 170 through the antenna of the electronic device 170 and the antenna 224 coupled with the antenna of the electronic device 170 and the transmission frequency of the signal (e.g., the signal including the authentication information) transmitted to the electronic device 170 from the accessory device 200-4 through the antenna 224 may be substantially about 13.56 (MHz). As a non-limiting example, a resonance frequency of the antenna 224 connected to the first impedance matching circuitry 601 among the first impedance matching circuitry 601 and the second impedance matching circuitry 602 or connected to both the first impedance matching circuitry 601 and the second impedance matching circuitry 602 may be slightly (or marginally) higher than 13.56 (MHz). For example, the resonance frequency may be about 14 (MHz).

As a non-limiting example, the signal transmitted to the external electronic device through the antenna of the electronic device 170 and the antenna 224 while the electronic device 170 is positioned within the receptacle 202 may be transmitted in response to another signal transmitted to the electronic device 170 within the receptacle 202 from the external electronic device. For example, the another signal may be received from the external electronic device through the antenna 224 connected to the first impedance matching circuitry 601 among the first impedance matching circuitry 601 and the second impedance matching circuitry 602 and the antenna of the electronic device 170 within the receptacle 202. As a non-limiting example, the another signal may be boosted by the antenna 224 coupled with the antenna of the electronic device 170 within the receptacle 202 and connected to the first impedance matching circuitry 601 among the first impedance matching circuitry 601 and the second impedance matching circuitry 602. For example, the antenna 224 connected to the first impedance matching circuitry 601 among the first impedance matching circuitry 601 and the second impedance matching circuitry 602 may be coupled with the antenna of the electronic device 170 within the receptacle 202 such that the signal transmitted to the electronic device 170 within the receptacle 202 from the external electronic device has enhanced reception quality within the electronic device 170 within the receptacle 202.

As a non-limiting example, the accessory device 200-4 may further include a filter 603 for a signal received from the electronic device 170 within the receptacle 202 (e.g., the signal including the authentication request) and/or a signal transmitted to the electronic device 170 within the receptacle 202 (e.g., the signal including the authentication information). For example, the filter 603 may be used to transmit a signal on a frequency (or frequencies) within a reference frequency range through the antenna 224 connected to the first impedance matching circuitry 601 and the second impedance matching circuitry 602 and/or to obtain, within the integrated circuitry 222-4, a signal on the frequency (or the frequencies) within the reference frequency range through the antenna 224 connected to the first impedance matching circuitry 601 and the second impedance matching circuitry 602. As a non-limiting example, the filter 603 may be embedded in the wall 204.

FIG. 6 illustrates the accessory device 200-4 including two impedance matching circuits (e.g., the first impedance matching circuitry 601 and the second impedance matching circuitry 602), but this is only an example. The accessory device 200-4 may also include one impedance matching circuitry (e.g., the second impedance matching circuitry 602) connected to the antenna 224 or disconnected from the antenna 224.

As described above, the accessory device 200-4 may include the antenna 224, which is a single antenna for supporting performing communication between the electronic device 170 within the receptacle 202 and the accessory device 200-4, performing communication between the electronic device 170 within the receptacle 202 and an external electronic device, and providing power to the circuitry 520 for providing information. For example, the accessory device 200-4 may include one or more impedance matching circuits (e.g., the second impedance matching circuitry 602) connected to the antenna 224 or disconnected from the antenna 224 to adjust a resonance frequency of the antenna 224 according to a function supported by the antenna 224 (e.g., communication between the electronic device 170 within the receptacle 202 and the accessory device 200-4 or communication between the electronic device 170 within the receptacle 202 and an external electronic device).

FIGS. 2, 3, 4, 5 and 6 illustrate various example accessory devices (e.g., the accessory device 200, the accessory device 200-1, the accessory device 200-2, the accessory device 200-3, and the accessory device 200-4) used with the electronic device 170. However, these are merely example. It should be noted that the above descriptions are applied to an accessory device used with a portable electronic device (e.g., a smartphone or a tablet) and another wearable device (e.g., a smart watch or a head mounted device (HMD)). For example, the accessory device used with the wearable device, which is the HMD, may include a single antenna such as the antenna 224. The accessory device may include at least a portion of components of the accessory device described with reference to FIGS. 2 to 6. The single antenna of the accessory device may support, through at least a portion of operations described above with reference to FIGS. 2 to 6, performing communication between the wearable device within the receptacle of the accessory device and the accessory device, performing communication between the wearable device within the receptacle of the accessory device and an external electronic device (e.g., including the electronic device 170), and obtaining power for displaying information on a display of the accessory device from the wearable device. For example, the information may be used to indicate a state of a part (e.g., an eye) of a body of a user wearing the wearable device.

The electronic device 170 described above with reference to FIGS. 1 to 6 may be implemented as the electronic device 701 of FIG. 7.

FIG. 7 is a block diagram illustrating an example electronic device 701 in a network environment 700 according to various example embodiments. Referring to FIG. 7, the electronic device 701 in the network environment 700 may communicate with an electronic device 702 via a first network 798 (e.g., a short-range wireless communication network), or at least one of an electronic device 704 or a server 708 via a second network 799 (e.g., a long-range wireless communication network). According to an embodiment, the electronic device 701 may communicate with the electronic device 704 via the server 708. According to an embodiment, the electronic device 701 may include a processor 720, memory 730, an input module 750, a sound output module 755, a display module 760, an audio module 770, a sensor module 776, an interface 777, a connecting terminal 778, a haptic module 779, a camera module 780, a power management module 788, a battery 789, a communication module 790, a subscriber identification module (SIM) 796, or an antenna module 797. In various embodiments, at least one of the components (e.g., the connecting terminal 778) may be omitted from the electronic device 701, or one or more other components may be added in the electronic device 701. In various embodiments, some of the components (e.g., the sensor module 776, the camera module 780, or the antenna module 797) may be implemented as a single component (e.g., the display module 760).

The processor 720 may execute, for example, software (e.g., a program 740) to control at least one other component (e.g., a hardware or software component) of the electronic device 701 coupled with the processor 720, and may perform various data processing or computation. According to an embodiment, as at least part of the data processing or computation, the processor 720 may store a command or data received from another component (e.g., the sensor module 776 or the communication module 790) in volatile memory 732, process the command or the data stored in the volatile memory 732, and store resulting data in non-volatile memory 734. According to an embodiment, the processor 720 may include a main processor 721 (e.g., a central processing unit (CPU) or an application processor (AP)), or an auxiliary processor 723 (e.g., a graphics processing unit (GPU), a neural processing unit (NPU), an image signal processor (ISP), a sensor hub processor, or a communication processor (CP)) that is operable independently from, or in conjunction with, the main processor 721. For example, when the electronic device 701 includes the main processor 721 and the auxiliary processor 723, the auxiliary processor 723 may be adapted to consume less power than the main processor 721, or to be specific to a specified function. The auxiliary processor 723 may be implemented as separate from, or as part of the main processor 721. Thus, the processor 720 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 723 may control at least some of functions or states related to at least one component (e.g., the display module 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). According to an embodiment, the auxiliary processor 723 (e.g., an image signal processor or a communication processor) may be implemented as part of another component (e.g., the camera module 780 or the communication module 790) functionally related to the auxiliary processor 723. According to an embodiment, the auxiliary processor 723 (e.g., the neural processing unit) may include a hardware structure specified for artificial intelligence model processing. An artificial intelligence model may be generated by machine learning. Such learning may be performed, e.g., by the electronic device 701 where the artificial intelligence is performed or via a separate server (e.g., the server 708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input module 750 may receive a command or data to be used by another component (e.g., the processor 720) of the electronic device 701, from the outside (e.g., a user) of the electronic device 701. The input module 750 may include, for example, a microphone, a mouse, a keyboard, a key (e.g., a button), or a digital pen (e.g., a stylus pen).

The sound output module 755 may output sound signals to the outside of the electronic device 701. The sound output module 755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 760 may visually provide information to the outside (e.g., a user) of the electronic device 701. The display module 760 may include, for example, a display, a hologram device, or a projector and control circuitry to control a corresponding one of the display, hologram device, and projector. According to an embodiment, the display module 760 may include a touch sensor adapted to detect a touch, or a pressure sensor adapted to measure the intensity of force incurred by the touch.

The audio module 770 may convert a sound into an electrical signal and vice versa. According to an embodiment, the audio module 770 may obtain the sound via the input module 750, or output the sound via the sound output module 755 or a headphone of an external electronic device (e.g., an electronic device 702) directly (e.g., wiredly) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. According to an embodiment, the sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device (e.g., the electronic device 702) directly (e.g., wiredly) or wirelessly. According to an embodiment, the interface 777 may include, for example, a high definition multimedia interface (HDMI), a universal serial bus (USB) interface, a secure digital (SD) card interface, or an audio interface.

A connecting terminal 778 may include a connector via which the electronic device 701 may be physically connected with the external electronic device (e.g., the electronic device 702). According to an embodiment, the connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or electrical stimulus which may be recognized by a user via his tactile sensation or kinesthetic sensation. According to an embodiment, the haptic module 779 may include, for example, a motor, a piezoelectric element, or an electric stimulator.

The camera module 780 may capture a still image or moving images. According to an embodiment, the camera module 780 may include one or more lenses, image sensors, image signal processors, or flashes.

The power management module 788 may manage power supplied to the electronic device 701. According to an embodiment, the power management module 788 may be implemented as at least part of, for example, a power management integrated circuitry (PMIC).

The battery 789 may supply power to at least one component of the electronic device 701. According to an embodiment, the battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the application processor (AP)) and supports a direct (e.g., wired) communication or a wireless communication. According to an embodiment, the communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or infrared data association (IrDA)) or the second network 799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The wireless communication module 792 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 792 may support a high-frequency band (e.g., the mmWave band) to achieve, e.g., a high data transmission rate. The wireless communication module 792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 792 may support various requirements specified in the electronic device 701, an external electronic device (e.g., the electronic device 704), or a network system (e.g., the second network 799). According to an embodiment, the wireless communication module 792 may support a peak data rate (e.g., 20Gbps or more) for implementing eMBB, loss coverage (e.g., 764dB or less) for implementing mMTC, or U-plane latency (e.g., 0.5ms or less for each of downlink (DL) and uplink (UL), or a round trip of 7ms or less) for implementing URLLC.

The antenna module 797 may transmit or receive a signal or power to or from the outside (e.g., the external electronic device) of the electronic device 701. According to an embodiment, the antenna module 797 may include an antenna including a radiating element including a conductive material or a conductive pattern formed in or on a substrate (e.g., a printed circuitry board (PCB)). According to an embodiment, the antenna module 797 may include a plurality of antennas (e.g., array antennas). In such a case, at least one antenna appropriate for a communication scheme used in the communication network, such as the first network 798 or the second network 799, may be selected, for example, by the communication module 790 (e.g., the wireless communication module 792) from the plurality of antennas. The signal or the power may then be transmitted or received between the communication module 790 and the external electronic device via the selected at least one antenna. According to an embodiment, another component (e.g., a radio frequency integrated circuitry (RFIC)) other than the radiating element may be additionally formed as part of the antenna module 797.

According to various embodiments, the antenna module 797 may form a mmWave antenna module. According to an embodiment, the mmWave antenna module may include a printed circuitry board, an RFIC disposed on a first surface (e.g., the bottom surface) of the printed circuitry board, or adjacent to the first surface and capable of supporting a designated high-frequency band (e.g., the mmWave band), and a plurality of antennas (e.g., array antennas) disposed on a second surface (e.g., the top or a side surface) of the printed circuitry board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 701 and the external electronic device 704 via the server 708 coupled with the second network 799. Each of the electronic devices 702 or 704 may be a device of a same type as, or a different type, from the electronic device 701. According to an embodiment, all or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 701. The electronic device 701 may provide the outcome, with or without further processing of the outcome, as at least part of a reply to the request. To that end, a cloud computing, distributed computing, mobile edge computing (MEC), or client-server computing technology may be used, for example. The electronic device 701 may provide ultra low-latency services using, e.g., distributed computing or mobile edge computing. In an embodiment, the external electronic device 704 may include an internet-of-things (IoT) device. The server 708 may be an intelligent server using machine learning and/or a neural network. According to an embodiment, the external electronic device 704 or the server 708 may be included in the second network 799. The electronic device 701 may be applied to intelligent services (e.g., smart home, smart city, smart car, or healthcare) based on 5G communication technology or IoT-related technology.

As described above, according to an example embodiment, an accessory device (e.g., the accessory device 200-3 or the accessory device 200-4) may be used with an electronic device (e.g., the electronic device 170). The accessory device may include a receptacle (e.g., the receptacle 202) including a bottom wall (e.g., the wall 204) and side walls (e.g., the side walls 208) extending from the bottom wall. The bottom wall and the side walls may define an internal volume having a size and a shape to receive the electronic device. The accessory device may include an antenna (e.g., the antenna 224) for near field communication (NFC), embedded in the bottom wall. The accessory device may include a power supply circuitry (e.g., the power supply circuitry 500 or the power supply circuitry 600), connected to the antenna and usable to obtain power for components of the accessory device from the electronic device positioned within the receptacle through the antenna. The accessory device may include a first linear regulator (e.g., the first linear regulator 511 or the first linear regulator 611) connected to the power supply circuit. The accessory device may include a second linear regulator (e.g., the second linear regulator 512 or the second linear regulator 612) connected to the power supply circuit. The accessory device may include an integrated circuitry (e.g., the integrated circuitry 222-3 or the integrated circuitry 222-4) connected to the antenna and connected to the power supply circuitry through the first linear regulator and including a wireless communication circuitry for NFC and memory. One or more nodes connecting the power supply circuitry and the antenna may also be connected to the integrated circuit. The accessory device may include a circuitry (e.g., the circuitry 520) connected to the power supply circuitry through the second linear regulator and usable to provide information. The memory may store instructions causing the integrated circuitry to support communication with the electronic device performed through the antenna to authenticate the accessory device in the electronic device positioned within the receptacle.

For example, the accessory device may further include a magnet (e.g., the target 226) embedded in the bottom wall and emitting an external magnetic field detectable by a magnetic field sensor of the electronic device positioned within the receptacle. The memory may store instructions causing the integrated circuitry to receive, using the wireless communication circuit, through the antenna, an authentication request transmitted based on detecting the external magnetic field from the electronic device positioned within the receptacle, according to first power obtained through the first linear regulator from the power supply circuit, and in response to the authentication request, support the communication according to transmitting authentication information through the antenna using the wireless communication circuit, in accordance with the first power.

For example, the information may be provided through the circuitry according to second power obtained through the second linear regulator from the power supply circuit.

For example, the antenna of the accessory device may be coupled with an antenna of the electronic device positioned within the receptacle.

For example, the bottom wall may include a first surface at least partially contacted with the electronic device positioned within the receptacle and a second surface opposite to the first surface. The antenna of the accessory device may be coupled with the antenna of the electronic device positioned within the receptacle to assist communication between the electronic device positioned within the receptacle and an external electronic device contacted to the second surface.

For example, a transmission frequency of a signal including the authentication information, transmitted through the antenna of the accessory device may be shifted from a transmission frequency of another signal transmitted through the antenna of the electronic device positioned outside the receptacle.

For example, a transmission frequency of a signal transmitted through the antenna of the accessory device for the communication between the electronic device within the receptacle and the external electronic device may be shifted from a transmission frequency of a signal transmitted through the antenna of the accessory device for communication between the electronic device positioned outside the receptacle and the external electronic device.

For example, the memory may store instructions causing the integrated circuitry to control the circuitry according to the first power to provide the information according to the second power.

For example, the accessory device may further include a cover (e.g., the cover 214) and a hinge (e.g., the hinge 218) allowing a relative movement between the cover and the receptacle. The cover may be configured to relatively rotate with respect to the side walls through the hinge and may be usable to conceal or protect the electronic device positioned within the receptacle and may include a first surface at least partially contacted with the electronic device positioned within the receptacle and a second surface opposite to the first surface. The information provided through the circuitry may be displayed on the second surface.

For example, a path for the second power from the power supply circuitry may extend to the circuitry embedded in the cover across the hinge.

For example, the authentication information may be associated with at least one of a serial number of the accessory device, a color of the accessory device, or a material of the accessory device.

For example, the authentication request and the authentication information may be usable to determine whether the accessory device is made by at least one of a manufacturer of the electronic device or an approved third-party accessory device manufacturer.

For example, the accessory device may further include a switch (e.g., the switch 604) embedded in the bottom wall and connected to the one or more nodes, a first impedance matching circuitry (e.g., the first impedance matching circuitry 601), embedded in the bottom wall, connected to the antenna, and connected to the one or more nodes, and a second impedance matching circuitry (e.g., the second impedance matching circuitry 602), embedded in the bottom wall, connected to the integrated circuit, and connected to the one or more nodes through the switch. The power supply circuitry may be connected to the antenna through the first impedance matching circuit. The switch may be usable to connect the integrated circuitry to the antenna through the first impedance matching circuitry and the second impedance matching circuit.

For example, the memory may store instructions causing the integrated circuitry to control the switch to change, according to first power obtained through the first linear regulator from the power supply circuit, a state of the switch, from a first state disconnecting the second impedance matching circuitry from the one or more nodes to a second state connecting the second impedance matching circuitry to the one or more nodes, while the integrated circuitry is connected to the antenna through the first impedance matching circuitry and the second impedance matching circuitry according to the switch in the second state, in accordance with the first power, receive, through the antenna using the wireless communication circuit, an authentication request transmitted based on detecting the external magnetic field from the electronic device positioned within the receptacle, and in accordance with the first power, transmit authentication information through the antenna using the wireless communication circuit, in response to the authentication request, and control the switch to change the state of the switch from the second state to the first state, based on transmitting the authentication information.

For example, a transmission frequency of a signal transmitted through the antenna connected to the first impedance matching circuitry and the second impedance matching circuitry through the switch may be different from a transmission frequency of a signal transmitted through the antenna connected to the first impedance matching circuitry and disconnected from the second impedance matching circuitry through the switch.

As described above, according to an example embodiment, an accessory device (e.g., the accessory device 200-2) may be used with an electronic device (e.g., the electronic device 170). The accessory device may include a receptacle (e.g., the receptacle 202) including a bottom wall (e.g., the wall 204) and side walls (e.g., the side walls 208) extending from the bottom wall. The bottom wall and the side walls may define an internal volume having a size and a shape to receive the electronic device. The accessory device may include an antenna (e.g., the antenna 224) for near field communication (NFC), embedded in the bottom wall. The accessory device may include a power supply circuitry (e.g., the power supply circuitry 400) connected to the antenna and usable to obtain power for components of the accessory device from the electronic device positioned within the receptacle through the antenna. The accessory device may include a switch (e.g., the switch 404). One or more nodes connecting the power supply circuitry and the antenna may also be connected to the switch. The accessory device may include an integrated circuitry (e.g., the integrated circuitry 222-2) connectable to the antenna through the switch and including a wireless communication circuitry for NFC and memory. The memory may store instructions causing the integrated circuitry to control the switch to set a state of the switch to a first state disconnecting the integrated circuitry from the antenna and control the switch to set the state of the switch to a second state connecting the integrated circuitry to the antenna.

For example, the accessory device may further include a magnet (e.g., the target 226) embedded in the bottom wall and emitting an external magnetic field detectable by a magnetic field sensor of the electronic device positioned within the receptacle. The memory may store instructions causing the integrated circuitry to control the switch to change a state of the switch from the first state to the second state in accordance with power obtained from the power supply circuit, while the integrated circuitry is connected to the antenna in accordance with the switch in the second state, in accordance with power obtained from the power supply circuit, receive, through the antenna using the wireless communication circuit, an authentication request transmitted based on detecting the external magnetic field from the electronic device positioned within the receptacle, and in accordance with the first power, transmit, through the antenna using the wireless communication circuit, authentication information, in response to the authentication request, and based on transmitting the authentication information, control the switch to change the state of the switch from the second state to the first state.

For example, the bottom wall may include a first surface at least partially contacted with the electronic device positioned within the receptacle and a second surface opposite to the first surface. For example, the antenna of the accessory device may be usable to assist communication between the electronic device positioned within the receptacle and an external electronic device contacted on the second surface, while the state of the switch is the first state.

For example, the accessory device may include a first impedance matching circuitry connected to the antenna and connected to the one or more nodes and a second impedance matching circuitry connected to the integrated circuitry and connectable to the one or more nodes through the switch. A transmission frequency of a signal transmitted through the antenna connected to the first impedance matching circuitry and the second impedance matching circuitry according to the switch in the second state may be different from a transmission frequency of a signal transmitted through the antenna connected to the first impedance matching circuitry and disconnected from the second impedance matching circuitry according to the switch in the first state.

For example, the accessory device may further include a linear regulator embedded in the bottom wall. For example, the integrated circuitry may be connected to the power supply circuitry through the linear regulator.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," or "connected with" another element (e.g., a second element), the element may be coupled with the other element directly (e.g., wiredly), wirelessly, or via a third element.

As used in connection with various embodiments of the disclosure, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuitry (ASIC).

Various embodiments as set forth herein may be implemented as software (e.g., the program 740) including one or more instructions that are stored in a storage medium (e.g., internal memory 736 or external memory 738) that is readable by a machine (e.g., the electronic device 701). For example, a processor (e.g., the processor 720) of the machine (e.g., the electronic device 701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the "non-transitory" storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An accessory device for use with an electronic device, the accessory device comprising:
a receptacle including a bottom wall and side walls extending from the bottom wall, wherein the bottom wall and the side walls define an internal volume having a size and a shape that receive the electronic device;
an antenna for near field communication (NFC), embedded in the bottom wall;
power supply circuitry usable for obtaining power for components of the accessory device through the antenna from the electronic device positioned in the receptacle;
a first linear regulator, comprising circuitry, connected to the power supply circuitry;
a second linear regulator, comprising circuitry, connected to the power supply circuitry;
integrated circuitry that is connected to the antenna, is connected through the first linear regulator to the power supply circuitry, and includes wireless communication circuitry for NFC and memory, wherein one or more nodes connecting the power supply circuitry to the antenna are also connected to the integrated circuitry; and
a circuit, connected through the second linear regulator to the power supply circuitry, usable for providing information;
wherein the memory stores instruction to cause the integrated circuitry to support communication with the electronic device performed through the antenna, to authenticate the accessory device in the electronic device positioned in the receptacle.

2. The accessory device of claim 1, comprising:
a magnet, embedded in the bottom wall, emitting an external magnetic field detectable by a magnetic field sensor of the electronic device position in the receptacle,
wherein the memory stores instructions that cause the integrated circuitry to support the communication to:
receive, by using the wireless communication circuitry, through the antenna, an authentication request transmitted from the electronic device positioned in the receptacle based on detecting the external magnetic field, according to first power obtained through the first linear regulator from the power supply circuitry; and
in response to the authentication request, transmit, by using the wireless communication circuitry, through the antenna, authentication information in accordance with the first power.

3. The accessory device of claim 2, wherein the information is provided through the circuit according to second power obtained through the second linear regulator from the power supply circuitry.

4. The accessory device of claim 3, wherein the antenna of the accessory device is coupled with an antenna of the electronic device positioned in the receptacle.

5. The accessory device of claim 4, wherein the bottom wall includes a first surface at least partially contacted with the electronic device positioned in the receptacle and a second surface opposite to the first surface, and
wherein the antenna of the accessory device is coupled with the antenna of the electronic device positioned in the receptacle to assist a communication between the electronic device positioned in the receptacle and an external electronic device contacted on the second surface.

6. The accessory device of claim 5, wherein a transmission frequency of a signal including the authentication information that is transmitted through the antenna of the accessory device is shifted from a transmission frequency of another signal transmitted through the antenna of the electronic device positioned outside of the receptacle.

7. The accessory device of claim 6, wherein a transmission frequency of a signal transmitted through the antenna of the accessory device for the communication between the electronic device positioned in the receptacle and the external electronic device is shifted from a transmission frequency of a signal transmitted through the antenna of the accessory device for a communication between the electronic device positioned outside of the receptacle and the external electronic device.

8. The accessory device of claim 3, wherein the memory stores instructions causing the integrated circuitry to control the circuit according to the first power to provide the information according to the second power.

9. The accessory device of claim 3, comprising:
a cover; and
a hinge allowing a relative movement between the cover and the receptacle,
wherein the cover is configured to relatively rotate with respect to the side walls through the hinge, is usable for concealing or protecting the electronic device positioned in the receptacle, and includes a first surface at least partially contacted with the electronic device positioned in the receptacle and a second surface opposite to the first surface, and
wherein the information provided through the circuit is displayed on the second surface.

10. The accessory device of claim 9, wherein a path for the second power from the power supply circuitry is extended to the circuit embedded in the cover across the hinge.

11. The accessory device of claim 2, wherein the authentication information is associated with at least one of a serial number of the accessory device, a color of the accessory device, or a material of the accessory device.

12. The accessory device of claim 2, wherein the authentication request and the authentication information are usable for determining whether the accessory device is made by a manufacturer of the electronic device and/or an approved third party accessory device manufacturer.

13. The accessory device of claim 1, comprising:
a switch, embedded in the bottom wall, connected to the one or more nodes;
first impedance matching circuitry that is embedded in the bottom wall, is connected to the antenna, and is connected to the one or more nodes; and
second impedance matching circuitry that is embedded in the bottom wall, is connected to the integrated circuit, and is connected through the switch to the one or more nodes,
wherein the power supply circuitry is connected through the first impedance matching circuitry to the antenna, and
wherein the switch is usable for connecting the integrated circuitry through the first impedance matching circuitry and the second impedance matching circuitry to the antenna.

14. The accessory device of claim 13, wherein the memory stores instructions causing the integrated circuitry to:
control the switch to change, according to first power obtained through the first linear regulator from the power supply circuitry, a state of the switch, from a first state disconnecting the second impedance matching circuitry from the one or more nodes to a second state connecting the second impedance matching circuitry to the one or more nodes,
while the integrated circuitry is connected to the antenna through the first impedance matching circuitry and the second impedance matching circuitry in accordance with the switch in the second state:
in accordance with the first power, receive, using the wireless communication circuitry, through the antenna, an authentication request transmitted from the electronic device positioned in the receptacle; and
in accordance with the first power, transmit, using the wireless communication circuitry, through the antenna, authentication information in response to the authentication request, and
based on transmitting the authentication information, control the switch to change the state of the switch from the second state to the first state.

15. The accessory device of claim 14, wherein a transmission frequency of a signal transmitted through the antenna connected to the first impedance matching circuitry and the second impedance matching circuitry via the switch is different from a transmission frequency of a signal transmitted through the antenna connected to the first impedance matching circuitry and disconnected from the second impedance matching circuitry.

16. An accessory device for use with an electronic device, the accessory device comprising:
a receptacle including a bottom wall and side walls extending from the bottom wall, wherein the bottom wall and the side walls define size and shape that receive the electronic device;
an antenna for near field communication (NFC), embedded in the bottom wall;
power supply circuitry usable for obtaining power for components of the accessory device through the antenna from the electronic device positioned in the receptacle;
a switch, wherein one or more nodes connecting the power supply circuitry to the antenna are also connected to the switch; and
integrated circuitry that is connectable to the antenna through the switch, and includes a wireless communication circuitry for NFC and memory,
wherein the memory stores instructions cause the integrated circuitry to:
control the switch to set a state of the switch to a first state disconnecting the integrated circuitry from the antenna; and
control the switch to set the state of the switch to a second state connecting the integrated circuitry to the antenna.

17. The accessory device of claim 16, comprising:
a magnet, embedded in the bottom wall, emitting an external magnetic field detectable by a magnetic field sensor of the electronic device positioned in the receptacle,
wherein the memory stores instructions causing the integrated circuitry to:
in accordance with power obtained from the power supply circuitry, control the switch to change a state of the switch from the first state to the second state,
while the integrated circuitry is connected to the antenna in accordance with the switch in the second state:
in accordance with power obtained from the power supply circuitry, receive, by using the wireless communication circuitry, through the antenna an authentication request transmitted from the electronic device positioned in the receptacle based on detecting the external magnetic field; and
in accordance with the power, transmit authentication information through the antenna by using the wireless communication circuitry in response to the authentication request, and
based on transmitting the authentication information, control the switch to change the state of the switch from the second state to the first state.

18. The accessory device of claim 17, wherein the bottom wall includes a first surface at least partially contacted with the electronic device positioned in the receptacle and a second surface opposite to the first surface, and
wherein the antenna of the accessory device is usable, while the state of the switch is the first state, for assisting a communication between the electronic device positioned in the receptacle and an external electronic device contacted on the second surface.

19. The accessory device of claim 16, further comprising:
first impedance matching circuitry, connected to the antenna, connected to the one or more nodes; and
second impedance matching circuitry, connected to the integrated circuitry, connected through the switch to the one or more nodes,
wherein a transmission frequency transmitted through the antenna connected to the first impedance matching circuitry and the second impedance matching circuitry according to the switch in the second state is different from a transmission frequency transmitted through the antenna connected to the first impedance matching circuitry and disconnected from the second impedance matching circuitry according to the switch in the first state.

20. The accessory device of claim 16, further comprising:
a linear regulator embedded in the bottom wall,
wherein the integrated circuitry is connected through the linear regulator to the power supply circuitry.
